(19) United States
(12) Patent Application Publication
(10) Pub. No.: US 2013/0176519 A1
(43) Pub. Date: Jul. 11, 2013

(54) SUBSTRATE FOR LIQUID CRYSTAL DISPLAY PANEL, LIQUID CRYSTAL DISPLAY PANEL, PROCESS OF MANUFACTURING SUBSTRATE FOR LIQUID CRYSTAL DISPLAY PANEL, AND SUBSTRATE TESTING METHOD

(71) Applicants: Takafumi Hayama, Osaka-shi (JP); Shinji Yamagishi, Osaka-shi (JP)

(72) Inventors: Takafumi Hayama, Osaka-shi (JP); Shinji Yamagishi, Osaka-shi (JP)

(73) Assignee: SHARP KABUSHIKI KAISHA, Osaka-shi, Osaka (JP)

(21) Appl. No.: 13/822,963

(22) PCT Filed: Sep. 22, 2011
(86) PCT No.: PCT/JP2011/071699

§ 371 Date: Mar. 18, 2013

(30) Foreign Application Priority Data
Sep. 29, 2010 (JP) 2010-219713

(51) Int. Cl. G02F 1/1333

(52) U.S. Cl. CPC G02F 1/13338
USPC 349/113; 445/58

(57) ABSTRACT

A liquid crystal display panel (1) includes: touch switches (50) each constituted by a switch electrode (52) of an active substrate (12) and a set of switch PS electrodes (51) of a counter substrate (11) so as to make conduct electricity when the active substrate (12) or the counter substrate (11) is pressed; and reflection coatings (38 and 39) which reflect infrared light emitted from a Fourier transform infrared spectrophotometer, the reflection coatings (38 and 39) being provided either in the active substrate (12) or the counter substrate (11) with the switch electrode (52) or the set of switch PS electrodes (51) stacked on a corresponding one of the reflection coatings (38 and 39). This provides a technique for efficiently determining the presence or absence of an alignment film on any touch switch provided inside of a liquid crystal display panel having the function of an in-cell touch sensor.

### TECHNICAL FIELD

The present invention relates to a liquid crystal display panel substrate that constitutes an in-cell liquid crystal display panel having touch switches disposed inside thereof, a liquid crystal display panel, a method for fabricating a liquid crystal display panel substrate, and a substrate inspection method.

### BACKGROUND ART

An in-cell touch panel has been developed as a type of touch panel that includes (i) a liquid crystal panel and (ii) “switch photo spacers (hereinafter sometimes referred to as ‘switch PSs’)”, formed in the liquid crystal panel, which function as touch switches.

FIG. 21 is a diagram showing a configuration of an in-cell touch panel provided with typical switch PSs.

As shown in FIG. 21, an in-cell touch panel 300 includes (i) a first substrate 301 whose front surface serves as a touch surface which an object whose position is to be detected, such as a stylus, touches, (ii) a liquid crystal layer 302, and (iii) a second substrate placed opposite the first substrate 301 with the liquid crystal layer 302 sandwiched therebetween. Disposed on a back surface of the first substrate 301 are color filters 311 corresponding to each separate subpixel, with a BM (black matrix) 312 provided between one subpixel and another.

Further disposed on the back surface of the first substrate 301 are switch PSs 313 protruding toward a front surface of the second substrate 303 (i.e., toward that surface of the second substrate 303 which faces the first substrate). The switch PSs 313 are placed at a distance from the second substrate 303.

The second substrate 303 has a transparent resin layer 321 formed on the front surface thereof, with pixel electrodes 322 disposed on a front surface of the transparent resin layer 321 for each separate subpixel.

Further, the second substrate 303 has switch electrodes 323 disposed on the front surface thereof so as to be in positions facing the switch PSs 313, respectively.

Disposed between the first substrate 301 and the second substrate 303 are main PSs 304 by which the distance between the first substrate 301 and the second substrate 303 (i.e., the thickness of the liquid crystal layer 302) is defined.

In the liquid crystal panel 300 thus configured, a user presses the front surface of the first substrate 301 directly with a stylus or the like. This brings the switch PSs 313 into contact with the switch electrodes 323 disposed on the second substrate 303, so that the position of the stylus or the like can be detected.

It should be noted here that in order to control the alignment of liquid crystals, a liquid crystal panel in general has an alignment film provided as the front (or back) surface of a substrate which is in contact with the liquid crystal layer.

However, an alignment film provided at a surface of contact between the switch PSs 313 and the switch electrodes 323 causes faulty electrical conduction therebetween whey they are in contact with each other.

Patent Literature 1 teaches the removal of an alignment film from a surface of a protrusion and from that surface of an electrode part which makes contact with the protrusion.

A liquid crystal display panel of Patent Literature 1 is described with reference to FIG. 22.

As shown in FIG. 22, a liquid crystal display panel 401 has a resistive touch sensor constituted by pixel electrodes 414 and counter sensor electrodes 422.

The pixel electrodes 414, provided on a first substrate 410, are provided with a plurality of slits 414A and a plurality of edges 414B. Moreover, on a second substrate 420 placed opposite the first substrate 410 with liquid crystals 430 sandwiched therebetween, a second space controlling column 401B is provided, with the counter sensor electrodes 422 provided on a back surface of the second space controlling column 401B.

The liquid crystal display panel 401 is configured such that the alignment film 415 becomes thinner toward each of the edges 414B so that the edges 414B are exposed, i.e., are not covered with the alignment film 415.

Further, the second space controlling column 401B thus formed has a height of approximately 2.5 μm. This height is not completely surpassed by an alignment film 423 that is provided on the side of the second substrate 420. This causes the alignment film 423 to be hardly formed at an apical end of the second space controlling column 401B.

In the liquid crystal display panel 401 thus configured, pressing down the front surface of the second substrate 420 with a finger or the like causes the counter sensor electrode 422 placed opposite the edges 414B to make contact with the exposed edges 414B of the pixel electrode 414. This ensures electrical conduction between the counter sensor electrode 422 and the edges 414B so as to suppress the instability with which the position of the finger or the like is detected.

Furthermore, Patent Literature 1 causes the edges 414 to be exposed by performing a rubbing process on the alignment film 415. Alternatively, by adding the step of performing an ashing process on the alignment film 415 after having formed the alignment film 415 and before performing the rubbing process, Patent Literature 1 reduces the thickness of the alignment film 415 so that the edges 414B can be easily exposed.

### CITATION LIST

Patent Literature 1
Japanese Patent Application Publication, Tokukai, No. 2009-251110 A (Publication Date: Oct. 29, 2009)

### SUMMARY OF INVENTION

### Technical Problem

In such an in-cell touch panel, even a slight residue of an alignment film on a contact surface of a switch PS or of a switch electrode causes faulty electrical conduction when the liquid crystal display panel is pressed down, thus making it impossible to perform accurate position detection.

Since the switch PSs 313 and the counter sensor electrodes 422 are each in the shape of a protrusion as shown in FIGS. 21 and 22, an alignment film can be prevented from being deposited on that surface of each of the switch PSs 131 or the counter sensor electrodes 422 which makes contact with the corresponding switch electrode 423 or the corresponding edges 414B. In practice, however, it is impossible to check (inspect) whether or not an alignment film has been formed on that surface of each of the switch PSs 131 or the counter sensor electrodes 422 which makes contact with the corresponding switch electrode 323 or the corresponding edges 414B.

That is, in general, the presence or absence of an alignment film is visually checked by a worker using an optical microscope. In this case, however, the worker has no choice but to judge the presence or absence of an alignment film by the color of the alignment film. This causes variations in the judgment among workers.

Another possible method for checking the presence or absence of an alignment film is to observe a cross-section with an SEM. However, such a method requires a lot of labor and time and destruction of a liquid crystal display panel, and as such, is not suitable to an actual production line.

As mentioned above, Patent Literature 1 renders the edges 414B easily exposable by performing a rubbing process or by adding the step of performing an ashing process. However, this method is similarly incapable of checking the presence or absence of an alignment film in a nondestructive manner, as the method gives no choice but to check a cross-section of each edge 414 with an SEM in order to check, on the surface of that edge 414, whether or not the alignment film has been really removed.

For the reasons stated above, it has been difficult to efficiently and surely check the presence or absence of an alignment film.

The present invention has been made in order to solve the foregoing problems, and it is an object of the present invention to provide a liquid crystal display panel substrate, a liquid crystal display panel, a liquid crystal display device, and a method for inspecting a liquid crystal display panel that make it possible to efficiently and surely check the presence or absence of an element that causes a failure to occur in a switch.

### Solution to Problem

In order to solve the foregoing problems, a liquid crystal display panel substrate of the present invention is a liquid crystal display panel substrate that constitutes a liquid crystal display panel by being placed opposite the other substrate with a liquid crystal layer sandwiched between the liquid crystal display panel substrate and the other substrate, the other substrate including a plurality of electrodes or plural sets of electrodes, the liquid crystal display panel substrate including: a plurality of switching electrodes or plural sets of switching electrodes each of which forms a switch with a corresponding one of the plurality of electrodes or with a corresponding one of the plural sets of electrodes, the plurality of switching electrodes or the plural sets of switching electrodes being each disposed so as to make electrical conduction with the corresponding one of the plurality of electrodes or with the corresponding one of the plural sets of electrodes when either the liquid crystal display panel substrate or the other substrate is pressed against the other with the liquid crystal display panel substrate placed opposite the other substrate; and reflection coatings which reflect infrared light, the reflection coatings being disposed below each separate one of the plurality of switching electrodes or below each separate one of the plural sets of switching electrodes.

According to the foregoing configuration, the plurality of switching electrodes or the plural sets of switching electrodes forms a switch with a corresponding one of the plurality of electrodes or with a corresponding one of the plural sets of electrodes of the other substrate when the liquid crystal display panel substrate is placed opposite the other substrate. Moreover, when either the liquid crystal display panel substrate or the other substrate is pressed against the other, the switch conducts electricity. This allows the switch to function as a sensor to detect the position of such electrical conduction.

Furthermore, according to the foregoing configuration, the reflection coatings, which reflect infrared light, are disposed below each separate one of the plurality of switching electrodes or below each separate one of the plural sets of switching electrodes. This allows infrared light let in through surfaces of the switching electrodes before the liquid crystal display panel substrate is placed opposite the other substrate to be reflected by the reflection coatings. Therefore, by measuring the spectrum of light reflected by the reflection coatings, an inspection can be carried out as to the presence or absence, on the surface of any of the switching electrodes, of an element that causes faulty electrical conduction with any of the electrodes of the other substrate.

This makes it possible to more efficiently and more surely check the presence or absence of an element that causes a failure to occur in any of those switches, as compared to the case of a visual check made with a microscope.

In order to solve the foregoing problems, a liquid crystal display panel of the present invention is a liquid crystal display panel including an active substrate, a liquid crystal layer, and a counter substrate placed opposite the active substrate with the liquid crystal layer sandwiched therebetween, the liquid crystal display panel including: switches each constituted by a first switching electrode or a set of first switching electrodes of the active substrate and a second switching electrode or a set of second switching electrodes of the counter substrate so as to conduct electricity when the active substrate or the counter substrate is pressed; and at least either first reflection coatings which reflect infrared light or second reflection coatings which reflect infrared light, the first reflection coatings being provided in the active substrate with the first switching electrode or the set of first switching electrodes stacked on a corresponding one of the first reflection coatings, the second reflection coatings being provided in the counter substrate with the second switching electrode or the set of second switching electrodes stacked on a corresponding one of the second reflection coatings.

According to the foregoing configuration, each of the switches is such that the first switching electrode or the set of first switching electrodes and the second switching electrode or the set of second switching electrodes make electrical conduction when the active substrate or the counter substrate is pressed. This allows each of the switches to function, for example, as a sensor to detect the position of such electrical conduction.

Furthermore, according to the foregoing configuration, the liquid crystal display panel includes at least either first reflection coatings which reflect infrared light or second reflection coatings which reflect infrared light, the first reflection coatings being provided in the active substrate with the first switching electrode or the set of first switching electrodes stacked on a corresponding one of the first reflection coatings, the second reflection coatings being provided in the counter substrate with the second switching electrode or the set of second switching electrodes stacked on a corresponding one of the second reflection coatings.

This allows infrared light let in through surfaces of those first or second switching electrodes before the active substrate and the counter substrate are placed opposite each other to be reflected by at least either the first or second reflection coatings. Therefore, by measuring the spectrum of light reflected by the first and second reflection coatings, an inspection can be carried out as to the presence or absence, on the surface of any of at least either the first or second switching electrodes, of an element that causes faulty electrical conduction between the first and second switching electrodes.

This makes it possible to more efficiently and more surely check the presence or absence of an element that causes a failure to occur in any of those switches, as compared to the case of a visual check made with a microscope.

In order to solve the foregoing problems, a method of the present invention for fabricating a liquid crystal display panel substrate is a method for fabricating a liquid crystal display panel substrate that constitutes a liquid crystal display panel being placed opposite the other substrate with a liquid crystal layer sandwiched between the liquid crystal display panel substrate and the other substrate, the other substrate including a plurality of electrodes or plural sets of electrodes, the method including: a reflection coating forming step of forming reflection coatings which reflect infrared light; a switching electrode forming step of forming, above each separate one of the reflection coatings formed in the reflection coating forming step, a plurality of switching electrodes or plural sets of switching electrodes each of which forms a switch with a corresponding one of the plurality of electrodes or with a corresponding one of the plural sets of electrodes, and each of which makes electrical conduction with the corresponding one of the plurality of electrodes or with the corresponding one of the plural sets of electrodes when either the liquid crystal display panel substrate or the other substrate is pressed against the other with the liquid crystal display panel substrate placed opposite the other substrate.

According to the foregoing arrangement, in the switching electrode forming step, the plurality of switching electrodes or the plural sets of switching electrodes are formed above each separate one of the reflection coatings, which reflect infrared light, formed in the reflection coating forming step. This makes it possible to fabricate a liquid crystal display panel that allows infrared light let in through surfaces of the switching electrodes to be reflected by the reflection coatings.

This makes it possible to fabricate a liquid crystal display panel that makes it possible that by measuring the spectrum of light reflected by the reflection coatings, an inspection can be carried out as to the presence or absence, on the surface of any of the switching electrodes, of an element that causes faulty electrical conduction with any of the electrodes of the other substrate.

This makes it possible to fabricate a liquid crystal display panel substrate that makes it possible to more efficiently and more surely check the presence or absence of an element that causes a failure to occur in any of those switches, as compared to the case of a visual check made with a microscope.

In order to solve the foregoing problems, a method of the present invention for inspecting a liquid crystal display panel substrate is a method for inspecting a liquid crystal display panel substrate that constitutes a liquid crystal display panel being placed opposite the other substrate with a liquid crystal layer sandwiched between the liquid crystal display panel substrate and the other substrate, the other substrate including a plurality of electrodes or plural sets of electrodes, the method including: an infrared light emitting step of emitting infrared light onto a plurality of switching electrodes or plural sets of switching electrodes each of which forms a switch with a corresponding one of the plurality of electrodes or with a corresponding one of the plural sets of electrodes of the other substrate, and each of which makes electrical conduction with the corresponding one of the plurality of electrodes or with the corresponding one of the plural sets of electrodes of the other substrate when either the liquid crystal display panel substrate or the other substrate is pressed against the other with the liquid crystal display panel substrate placed opposite the other substrate; and a reflected light obtaining step of obtaining reflected light from reflection coatings reflecting the infrared light emitted in the infrared light emitting step, when the liquid crystal display panel substrate is seen in plan view, each of the reflection coatings appearing to be overlapping a corresponding one(s) of the switching electrodes.

The foregoing arrangement includes: the infrared light emitting step of emitting infrared light onto the plurality of switching electrodes or the plural sets of switching electrodes; and the reflected light obtaining step of obtaining reflected light from reflection coatings reflecting the infrared light emitted in the infrared light emitting step, with the switching electrodes or the plural sets of switching electrodes stacked on each separate one of the reflection coatings. This makes it possible to determine, from the reflected light thus obtained, the presence or absence, on the surface of any of the switching electrodes, an element that causes faulty electrical conduction with any of the electrodes of the other substrate.

For this reason, the foregoing arrangement makes it possible to efficiently and surely check the presence or absence of an element that causes a failure to occur in any of those switches.

### Advantageous Effects of Invention

A liquid crystal display panel substrate of the present invention constitutes a liquid crystal display panel by being placed opposite the other substrate with a liquid crystal layer sandwiched between the liquid crystal display panel substrate and the other substrate, the other substrate including a plurality of electrodes or plural sets of electrodes, and the liquid crystal display panel substrate includes: a plurality of switching electrodes or plural sets of switching electrodes each of which forms a switch with a corresponding one of the plurality of electrodes or with a corresponding one of the plural sets of electrodes, the plurality of switching electrodes or the plural sets of switching electrodes being each disposed so as to make electrical conduction with the corresponding one of the plurality of electrodes or with the corresponding one of the plural sets of electrodes when either the liquid crystal display panel substrate or the other substrate is pressed against the other with the liquid crystal display panel substrate placed opposite the other substrate; and reflection coatings which reflect infrared light, the reflection coatings being disposed below each separate one of the plurality of switching electrodes or below each separate one of the plural sets of switching electrodes.

A liquid crystal display panel of the present invention includes an active substrate, a liquid crystal layer, and a counter substrate placed opposite the active substrate with the liquid crystal layer sandwiched therebetween. Further, the liquid crystal display panel includes: switches each constituted by a first switching electrode or a set of first switching electrodes of the active substrate and a second switching electrode or a set of second switching electrodes of the counter substrate so as to conduct electricity when the active substrate or the counter substrate is pressed; and at least either first reflection coatings which reflect infrared light or second reflection coatings which reflect infrared light, the first reflection coatings being provided in the active substrate with the first switching electrode or the set of first switching electrodes stacked on a corresponding one of the first reflection coatings, the second reflection coatings being provided in the counter substrate with the second switching electrode or the set of second switching electrodes stacked on a corresponding one of the second reflection coatings.

A method of the present invention for fabricating a liquid crystal display panel substrate is a method for fabricating a liquid crystal display panel substrate that constitutes a liquid crystal display panel being placed opposite the other substrate with a liquid crystal layer sandwiched between the liquid crystal display panel substrate and the other substrate, the other substrate including a plurality of electrodes or plural sets of electrodes, the method including: a reflection coating forming step of forming reflection coatings which reflect infrared light; a switching electrode forming step of forming, above each separate one of the reflection coatings formed in the reflection coating forming step, a plurality of switching electrodes or plural sets of switching electrodes each of which forms a switch with a corresponding one of the plurality of electrodes or with a corresponding one of the plural sets of electrodes, and each of which makes electrical conduction with the corresponding one of the plurality of electrodes or with the corresponding one of the plural sets of electrodes when either the liquid crystal display panel substrate or the other substrate is pressed against the other with the liquid crystal display panel substrate placed opposite the other substrate.

A method of the present invention for inspecting a liquid crystal display panel substrate is a method for inspecting a liquid crystal display panel substrate that constitutes a liquid crystal display panel being placed opposite the other substrate with a liquid crystal layer sandwiched between the liquid crystal display panel substrate and the other substrate, the other substrate including a plurality of electrodes or plural sets of electrodes, the method including: an infrared light emitting step of emitting infrared light onto a plurality of switching electrodes or plural sets of switching electrodes each of which forms a switch with a corresponding one of the plurality of electrodes or with a corresponding one of the plural sets of electrodes of the other substrate, and each of which makes electrical conduction with the corresponding one of the plurality of electrodes or with the corresponding one of the plural sets of electrodes of the other substrate when either the liquid crystal display panel substrate or the other substrate is pressed against the other with the liquid crystal display panel substrate placed opposite the other substrate; and a reflected light obtaining step of obtaining reflected light from reflection coatings reflecting the infrared light emitted in the infrared light emitting step, when the liquid crystal display panel substrate is seen in plan view, each of the reflection coatings appearing to be overlapping a corresponding one(s) of the switching electrodes.

This brings about an effect of making it possible to efficiently and surely check the presence or absence of an element that causes a failure to occur in any of those switches.

### BRIEF DESCRIPTION OF DRAWINGS

FIG. 1 is a cross-sectional view taken along the line A-A′ show in FIGS. 2 and 3.

FIG. 2 is a plan view showing a configuration of a counter substrate of a liquid crystal display device according a first embodiment of the present invention.

FIG. 3 is a plan view showing a configuration of an active substrate of a liquid crystal display device according the first embodiment of the present invention.

FIG. 4 is a cross-sectional view taken along the line V-V′ show in FIG. 3.

FIG. 5 is a diagram showing an equivalent circuit of a liquid crystal display panel of the present invention.

FIG. 6 is a flow chart explaining steps of a process for fabricating a liquid crystal display panel of the present invention.

FIG. 7 is a set of diagrams showing a method for fabricating a counter substrate of a liquid crystal display panel of the present invention.

FIG. 8 is a set of diagrams explaining a method for removing an alignment film from an apical end of each switch PS electrode of a counter substrate of the present invention.

FIG. 9 is a diagram showing a modification of each switch PS electrode of a counter substrate of the present invention.

FIG. 10 is a set of diagrams explaining a method for fabricating an active substrate of the present invention.

FIG. 11 is a set of diagrams (a) and (b), (a) being a diagram showing how a substrate having a PI residue on a switching electrode is inspected, (b) being a diagram showing how a substrate having no PI residue on a switching electrode is inspected.

FIG. 12 is a diagram showing a spectrum that is displayed on a display section in a case where there is a PI residue found.

FIG. 13 is a diagram showing a spectrum that is displayed on the display section in a case where there is no PI residue found.

FIG. 14 is a diagram explaining positions of molecular vibrations by infrared absorption.

FIG. 15 is a cross-sectional view showing a configuration of a touch switch provided in a liquid crystal display panel according to a second embodiment of the present invention.

FIG. 16 is a plan view showing a configuration of a switch electrode of an active substrate according to the second embodiment of the present invention.

FIG. 17 is a cross-sectional view showing a configuration of a touch switch provided in a liquid crystal display panel according to a third embodiment of the present invention.

FIG. 18 is a diagram showing a configuration of a switching electrode inspection apparatus according to a fourth embodiment of the present invention.

FIG. 19 is a diagram showing results of determination of the presence or absence of PI residues, as displayed on the display section.

FIG. 20 is a diagram showing a spectrum indicating that there is no PI residue found on a surface of a switch electrode.

FIG. 21 is a diagram showing a configuration of an in-cell touch panel provided with conventional switch PSs.

FIG. 22 is a cross-sectional view showing a configuration of a conventional liquid crystal display panel.

### DESCRIPTION OF EMBODIMENTS

Embodiments of the present invention are described in detail below.

### Embodiment 1

(Configuration of a Liquid Crystal Display Device as Schematically Described)

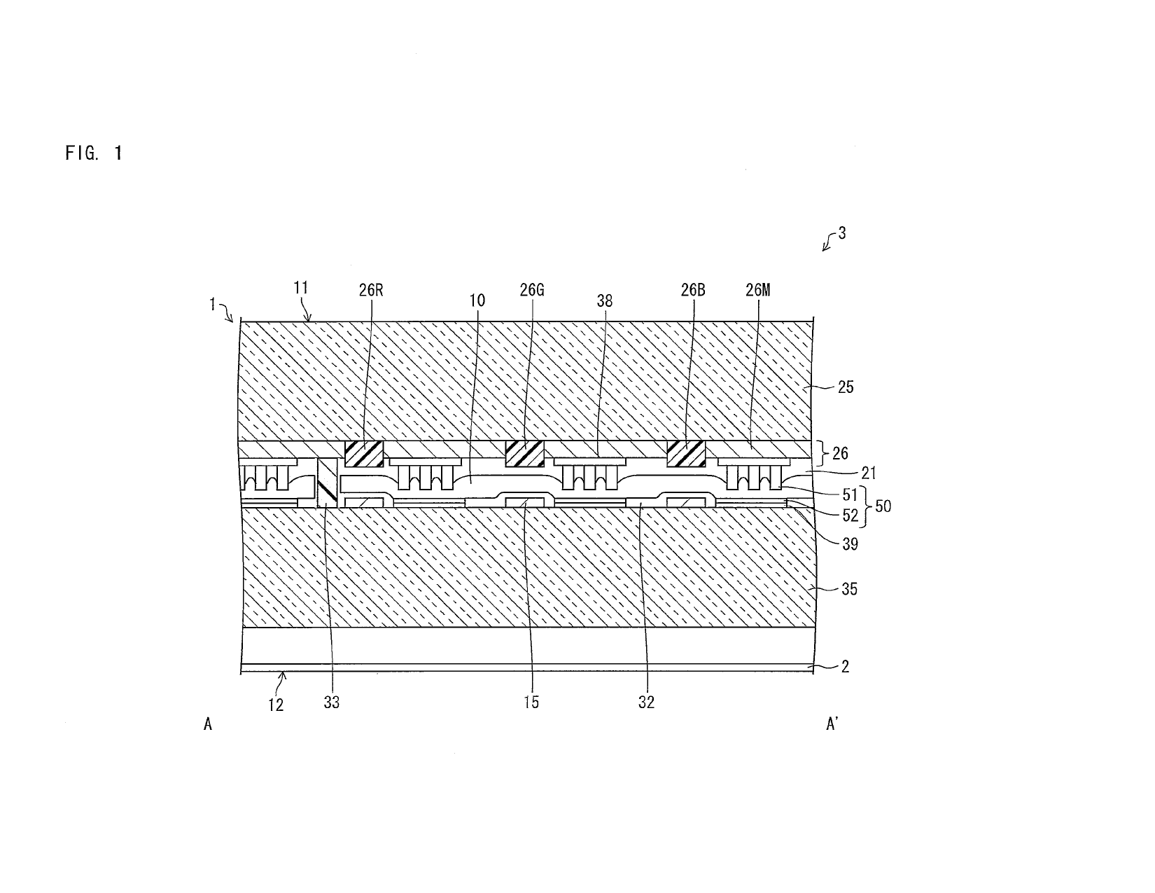

First, a configuration of a liquid crystal display device according to the present embodiment is schematically described with reference to FIGS. 1 through 3.

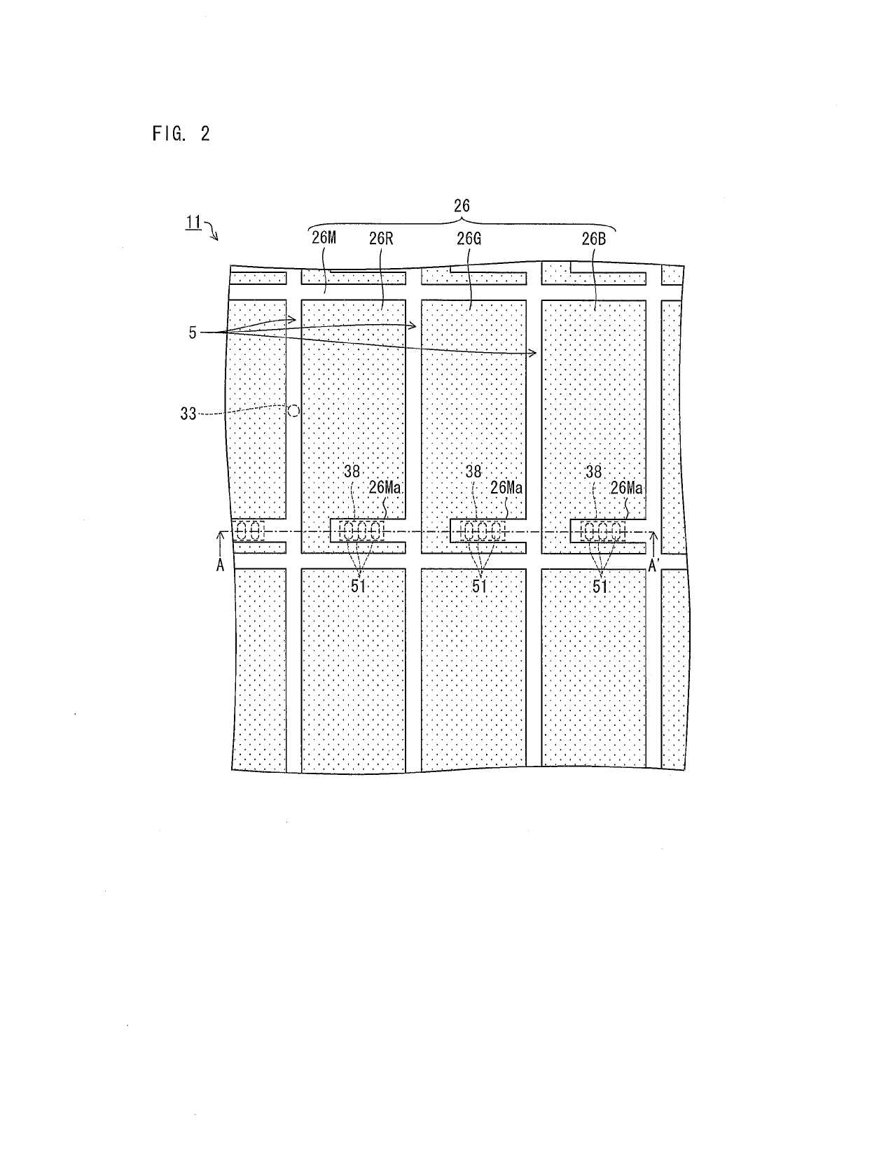

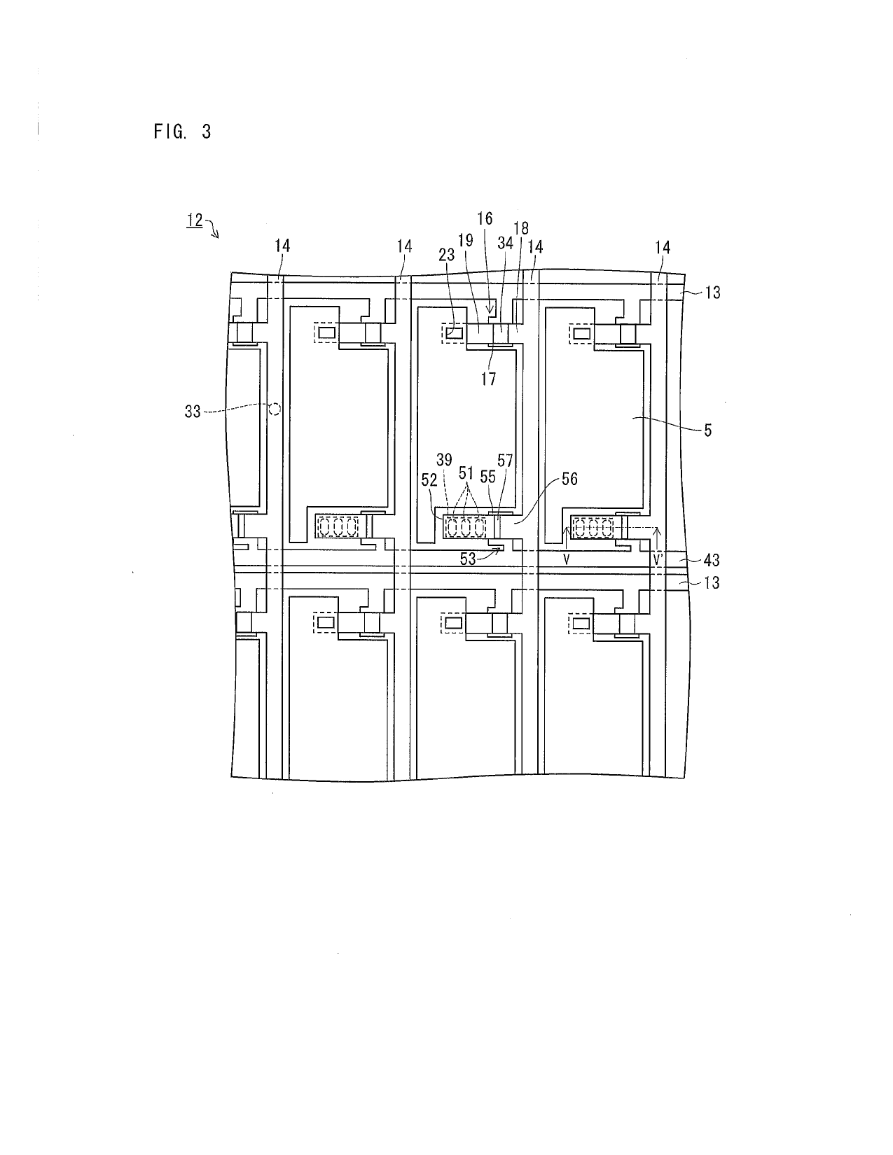

FIG. 2 is a plan view showing a configuration of a counter substrate of the liquid crystal display device according to the present embodiment. FIG. 3 is a plan view showing a configuration of an active substrate of the liquid crystal display device according to the present embodiment.

FIG. 1 is a cross-sectional view taken along the line A-A′ show in FIGS. 2 and 3.

As shown in FIG. 1, a liquid crystal display device 3 includes a liquid crystal display panel 1 and a backlight 2. Further, the liquid crystal display device 3 includes driving control circuits (not illustrated) etc. These driving control circuits control driving of the liquid crystal display panel 1 and the backlight 2, respectively.

The liquid crystal display panel 1 has touch switches (switches) 50 formed inside thereof as touch sensors. Therefore, the liquid crystal display panel 1 is a liquid crystal display panel that has the function of an in-cell touch sensor, and as such, functions as a touch panel.

The present embodiment can provide a technique that makes it possible to efficiently determine the presence or absence of an alignment film on a touch switch provided inside of such a liquid crystal display panel having the function of an in-cell touch sensor.

The liquid crystal display panel 1 includes an active substrate (second substrate) 12, a liquid crystal layer 10, and a counter substrate (first substrate) 11 placed opposite the active substrate 12 with the liquid crystal layer 10 sandwiched therebetween.

The backlight 2, provided on a back surface side of the active substrate 12 (i.e., on that side of the active substrate 12 which faces away from the liquid crystal layer 10), is an illumination device that illuminates the liquid crystal display panel 1.

Formed between the counter substrate (liquid crystal display panel substrate, other substrate) 11 and the active substrate (other substrate, liquid crystal display panel substrate) 12 are spacers 33, i.e., photo spacers, by which the distance (i.e., the cell gap) between the counter substrate 11 and the active substrate 12 is defined. The spacers 33 serve as main PSs (photo spacers).

The counter substrate 11 includes at least a glass substrate 25, a color filter layer 26, reflection coatings (second reflection coatings) 38, switch PS electrodes (switching electrodes, sets of switching electrodes, electrodes of the other substrate, sets of electrodes of the other substrate, second switching electrodes) 51, and an alignment film 21.

The glass substrate 25 has a thickness of approximately 0.7 mm or smaller, for example. Moreover, provided on a front surface of the glass substrate 25 (i.e., on that surface of the glass substrate 25 which faces away from the active substrate 12) is a polarizing plate (not illustrated) whose front surface serves as a touch surface which an object whose position is to be detected, such as a user's finger or a stylus, touches. The touch surface is also a surface that is pressed by the object.

The color filter layer 26 is provided on a back surface of the glass substrate 25 (i.e., on that surface of the glass substrate 25 which faces the active substrate 12).

The reflection coatings 38 are disposed on a back surface of the color filter layer 26 (i.e., on that surface of the color filter layer 26 which faces the active substrate 12). The reflection coatings 38 are made of a metal material or, in particular, are made of a material that reflects infrared light emitted from a Fourier transform infrared spectrophotometer or the like.

Furthermore, it is preferable that the metal material of which the reflection coatings 38 are made be the same as the metal material of which wires or electrodes of the active substrate 12 are made. This eliminates the need to prepare another metal material for forming the reflection coatings 38, thus making it possible to suppress a rise in manufacturing cost.

It is preferable that the reflection coatings 38 be constituted by a single layer and be composed mainly of tantalum (Ta), molybdenum (Mo), titanium (Ti), copper (Cu), or aluminum (Al). This allows the reflection coatings 38 to be made of the same metal material as that of which the wires of the active substrate 12 are made.

This eliminates the need to prepare another metal material for forming the reflection coatings 38, thus making it possible to suppress a rise in manufacturing cost.

It should be noted that the reflection coatings 38 do not need to be constituted by a single layer but may be constituted by a plurality of layers each composed mainly of any one of the aforementioned metal materials, namely tantalum (Ta), molybdenum (Mo), titanium (Ti), copper (Cu), and aluminum (Al).

The reflection coatings 38 are not to be particularly limited in thickness, and as such, need only have a thickness that does not affect a member that is to be deposited after formation of the reflection coatings 38. For example, the reflection coatings 38 have a thickness of approximately 50 nm.

The switch PS electrodes 51 are disposed on back surfaces of the reflection coatings 38 (i.e., on those surfaces of the reflection coatings 38 which face the active substrate 12). As will be described later, each of the switch PS electrodes 51 is constituted by a columnar transparent resin material and a transparent electrode serving as a common electrode covering a surface of the transparent resin material.

The switch PS electrodes 51 are provided so as to protrude from the back surfaces of the reflection coatings 38 toward the active substrate 12, and are at a distance from switch electrodes 52 (to be described later) of the active substrate 12. That is, each of the switch PS electrodes 51 is in the shape of a protrusion. It should be noted that a configuration of each of the switch PS electrodes 51 will be described later in detail.

The alignment film 21 is made, for example, of polyimide (PI). The alignment film 21 is provided at the boundary of the counter substrate 11 with the liquid crystal layer 10, except for an apical surface of each of the switch PS electrodes 51 (i.e., except for that surface of each of the switch PS electrodes 51 which faces the corresponding switch electrode 52). It should be noted that the counter substrate 11 has a transparent electrode (not illustrated in FIG. 1) stacked to serve as a common electrode.

The alignment film 21 covers the color filter layer 26, the reflection coatings 38, side surfaces of the switch PS electrodes 51, and side surfaces of the spacers 33 with the transparent electrode sandwiched therebetween. That is, the transparent electrode is exposed on the apical surface of each of the switch PS electrodes 51.

The active substrate 12 includes at least a glass substrate 35, pixel electrodes 15, reflection coatings (first reflection coatings) 39, the switch electrodes 52, and an alignment film 32.

The glass substrate 35 has a thickness of approximately 0.7 mm or smaller, for example. Moreover, provided on a back surface of the glass substrate 35 (i.e., on that surface of the glass substrate 35 which faces the backlight 2) is a polarizing plate (not illustrated).

Each of the reflection coatings 39 is located in a region where the corresponding switch electrode 52 is provided and which faces the corresponding switch PS electrodes 51.

As with the reflection coatings 38, the reflection coatings 39 are made of a metal material or, in particular, are made of a material that reflects infrared light emitted from a Fourier transform infrared spectrophotometer or the like.

It is preferable that the reflection coatings 39 be constituted by a single layer and be composed mainly of tantalum (Ta), molybdenum (Mo), titanium (Ti), copper (Cu), or aluminum (Al).

This allows the reflection coatings 38 to be made of the same metal material as that of which the wires of the active substrate 12 are made. This eliminates the need to prepare another metal material for forming the reflection coatings 39, thus making it possible to suppress a rise in manufacturing cost.

It should be noted that the reflection coatings 39 do not need to be constituted by a single layer but may be constituted by a plurality of layers each composed mainly of any one of the aforementioned metal materials, namely tantalum (Ta), molybdenum (Mo), titanium (Ti), copper (Cu), and aluminum (Al).

The reflection coatings 39 are not to be particularly limited in thickness, and as such, need only have a thickness that does not affect a member that is to be deposited after formation of the reflection coatings 39. For example, the reflection coatings 38 have a thickness of approximately 50 nm.

The switch electrodes 52 are stacked on the reflection coatings 39, respectively. Each of the switch electrodes 52 is placed in such a region as to face the corresponding switch PSs 51. That is, each of the switch electrodes 52 is in such a position as to make contact with the corresponding switch PSs 51 when the corresponding switch PSs 51 are pressed.

The switch PS electrodes 51 and the switch electrodes 52, which will be described later, constitute the touch switches 50 provided in the liquid crystal display panel 1 to function as touch sensors.

Thus, each of the touch switches 50 includes switch PS electrodes 51 and a switch electrode 52, and each of the switch PS electrodes 51 is in the shape of a protrusion. This allows the switch PS electrodes 51 and the switch electrode 52 to make contact with each other for electrical conduction when the counter substrate 11 or the active substrate 12 is pressed. This is how each of the touch switches 50 is configured.

In the present embodiment, as will be described later, each of the switch electrodes 52 also serves as a drain electrode for a position detector TFT of the corresponding touch switch 50.

The alignment film 32 is made, for example, of polyimide (PI). The alignment film 32 is provided at the boundary of the active substrate 12 with the liquid crystal layer 10, except for a surface of each of the switch electrodes 52. That is, the alignment film 32 covers the glass substrate 35, the pixel electrodes 15, and the side surfaces of the spacers 33.

(Configuration of the Color Filter Layer)

Next, the color filter layer 26 is described with reference to FIG. 2.

As shown in FIG. 2, the color filter layer 26 includes (i) colored layers 26R, 26G, 26B disposed in each separate pixel 5 and (ii) a light-shielding layer (black matrix) 26M provided between the adjacent colored layers 26R, 26G, and 26B. That is, the colored layers 26R, 26G, and 26B are disposed in regions demarcated from one another by the light-shielding layer 26M, respectively.

The colored layers 26R selectively transmit light at red wavelengths. The colored layers 26G selectively transmit light at green wavelengths. The colored layers 26B selectively transmit light at blue wavelengths.

Further, the light-shielding layer 26M has parts that appear to extend vertically on the counter substrate 11 when the counter substrate 11 is seen in plan view, and some of the parts serve as protruding parts 26Ma that protrude into the respective pixels 5. Each of the protruding parts 26Ma covers a detector TFT (to be described later) for controlling driving of the corresponding touch switch 50. Provided on a back surface of each of the protruding parts 26Ma are a reflection coating 38 and switch PS electrodes 51.

(Configuration of the Active Substrate)

FIG. 3 is a plan view showing a configuration of the active substrate 12.

The active substrate 12 has a plurality of gate wires 13 extending parallel to each other, a plurality of detector wires 43 extending parallel to each other, and a plurality of source wires 14 extending parallel to each other.

The gate wires 13, the detector wires 43, and the source wires 14 are made of a metal material composed mainly of tantalum (Ta), molybdenum (Mo), titanium (Ti), copper (Cu), or aluminum (Al).

The plurality of gate wires 13 and the plurality of detector wires 43 extend parallel to each other, and the plurality of source wires 14 intersect the plurality of gate wires 13 and the plurality of detector wires 43. When the active substrate 12 is seen in plan view, the plurality of gate wires 13 and the plurality of detector wires 43 appear to extend horizontally, and the plurality of source wires 14 appear to extend vertically.

When the liquid crystal display panel 1 is seen in plan view, the pixels 5 appear to be demarcated from each other in a reticular pattern by the gate wires 13, the detector wires 43, and the source wires 14.

Formed in each of the pixels 5 are a TFT (thin film transistor) 16, a pixel electrode 15, and a switch electrode 52.

The TFT 16 includes a gate electrode 17, a source electrode 18, and a drain electrode 19. The gate electrode 17, the source electrode 18, and the drain electrode 19 are made of a metal material composed mainly of tantalum (Ta), molybdenum (Mo), titanium (Ti), copper (Cu), or aluminum (Al).

Interposed between the gate electrode 17 and the source electrode 18 and between the gate electrode 17 and the drain electrode 19 is a semiconductor layer 34. The gate electrode 17 is connected to a gate wire 13. The source electrode 18 is connected to a source wire 14. The drain electrode 19 is connected to the pixel electrode 15.

The drain electrode 19 is covered with an interlayer insulating film (not illustrated) provided with a contact hole through which the drain electrode 19 and the pixel electrode 15 are connected to each other.

The pixel electrode 15 is a transparent electrode made of ITO or the like. The pixel electrode 15 is placed in such a region as to face its corresponding one of the colored layers 26R, 26G, and 26B. Application of a voltage to the pixel electrode 15 by the TFT 16 causes a potential difference to be generated between the pixel electrode 15 and the common electrode of the counter substrate 11. This allows the liquid crystal layer 10 to have its liquid crystals controlled to be driven so that the liquid crystal display panel 1 can display an image.

Further provided in each of the pixels 5 is a position detector TFT 53 for use in the corresponding touch switch 50. The detector TFT 53 includes a gate electrode 55, a source electrode 56, and a drain electrode serving as the corresponding switch electrode 52. The gate electrode 55 and the source electrode 56 are made of a metal material composed mainly of tantalum (Ta), molybdenum (Mo), titanium (Ti), copper (Cu), or aluminum (Al).

Interposed between the gate electrode 55 and the source electrode 56 and between the gate electrode 55 and the switch electrode 52 (drain electrode 19) is a semiconductor layer 57. The gate electrode 55 is connected to a detector wire 43, and the source electrode 56 is connected to a source wire 14.

The switch electrode 52 is placed at least in such a region as to face the corresponding switch PS electrodes 51. The switch electrode 52 is a transparent electrode made of ITO or the like, and can be formed by the same process as that used in forming the pixel electrode 15.

(Cross-Sectional Structures in an Area Around a Touch Switch)

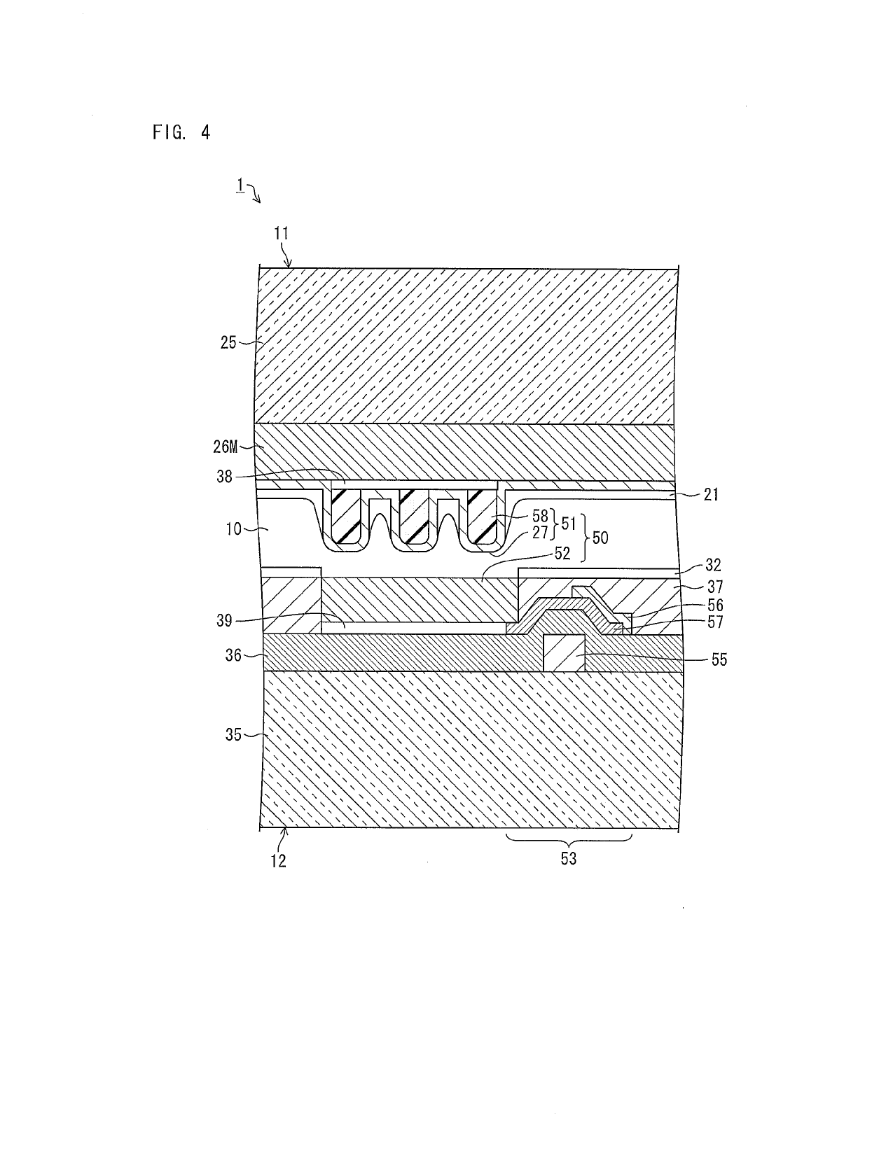

Next, cross-sectional structures of the active substrate 12 and the counter substrate 11 in an area around a touch switch 50 are described with reference to FIG. 4.

FIG. 4 is a cross-sectional view taken along the line V-V′ shown in FIG. 3.

First, a cross-sectional structure of the active substrate 12 is described.

As shown in FIG. 4, the active substrate 12 has a gate electrode 55 formed on a front surface of the glass substrate 35. Moreover, the active substrate 12 has a gate insulating film 36 formed on the front surface of the glass substrate 35 so as to cover the gate electrode 55.

The active substrate 12 has a semiconductor layer 57 formed on a front surface of the gate insulating film 36 so as to be in that region of the front surface which covers the gate electrode 55. The active substrate 12 has a reflection coating 39 formed on the front surface of the gate insulating film 36 so as to be in that region of the front surface where the switch electrode 52 is provided, i.e., in that region of the front surface which faces the switch PS electrodes 51.

Moreover, the switch electrode 52 covers the reflection coating 39 and part of the semiconductor layer 57. Further, the active substrate 12 has a source electrode 56 formed so as to cover the front surface of the gate insulating film 36 and another part of the semiconductor layer 57.

The active substrate 12 has an interlayer insulating film 37 formed on the gate insulating film 36 and on the semiconductor layer 57 so as to cover the source electrode 56.

The interlayer insulating film 37 is made, for example, of a resin having translucency. More preferably, the interlayer insulating film 37 is made of a resin having transparency. Specifically, the interlayer insulating layer 37 is made of acrylic. Moreover, the active substrate 12 has its alignment film 32 stacked on a front surface of the interlayer insulating film 37.

The switch electrode 52 has its front surface (which faces the counter substrate 11) uncovered with the interlayer insulating film 37 or the alignment film 32, i.e., has its front surface exposed.

It should be noted that the reflection coating 39 may or may not be in contact with the semiconductor layer 57, provided that the reflection coating 39 is placed so that electrical conduction is ensured between the switch electrode 52 and the semiconductor layer 57.

Next, a cross-sectional structure of the counter substrate 11 is described.

The counter substrate 11 has its light-shielding layer 26M formed on the back surface of the glass substrate 25. The counter substrate 11 has a reflection coating 38 formed on the back surface of the light-shielding layer 26M so as to be in that region of the back surface which faces the switch electrode 52. The counter substrate 11 has a plurality of columnar switch PS electrodes 51 formed on a back surface of the reflection coating 38. In the present embodiment, the counter substrate 11 has a set of three switch PS electrodes 51 formed for each separate reflection coating 38.

Each of the switch PS electrodes 51 is constituted by (i) a switch PS (structure) 58 formed on the reflection coating 38 and (ii) a transparent electrode 27 covering all of those switch PSs 58. Moreover, the transparent electrode 27 covers the light-shielding layer 26M, the switch PSs 58, and the reflection coating 38.

Moreover, the transparent electrode 27 is covered with the alignment film 21, except for an apical surface of each of the switch PS electrodes 51. That is, the transparent electrode 27 is exposed on the apical surface of each of the switch PS electrodes 51.

Each of the switch PSs 58 is in the shape of a protrusion. The switch PSs 58 are made of acrylic, and as such, can be made of the same material as that of which the interlayer insulating film 37 of the active substrate 12 is made. This eliminates the need to use another material to form the switch PSs 58, thus making it possible to prevent a rise in manufacturing cost.

(Method for Detecting the Position of an Area Touched)

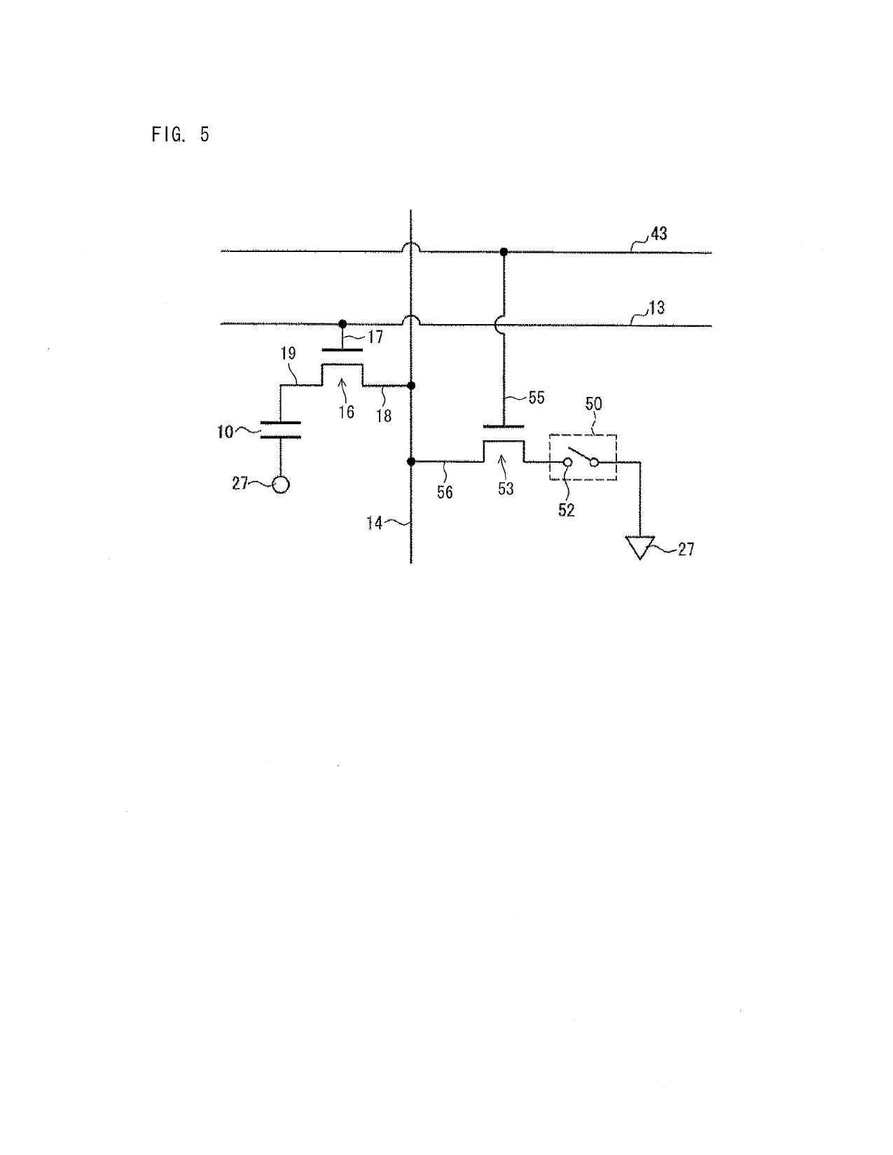

Next, a method for detecting the position of an area touched on the liquid crystal display panel 1 is described with reference to FIG. 5.

FIG. 5 is a diagram showing an equivalent circuit of the liquid crystal display panel 1.

A predetermined scanning voltage is applied to a detector wire 43. Then, the detector TFT 53 connected to that detector wire 43 is brought into an ON state, so that the switch electrode 52 and the source electrode 56 conduct.

When, at this point in time, the transparent electrode 27, formed at the apical end of each of the switch PS electrodes 51, and the switch electrode 52 are brought into contact with each other by a user pressing the touch surface of the liquid crystal display panel 1, the transparent electrode 27 and the switch electrode 52 become conductive. This causes an electric current corresponding to a common voltage being applied to the transparent electrode 27 to flow through the source electrode 14. The position of an area touched can be detected by detecting such an electric current having flowed through the source electrode 14.

A position on the liquid crystal display panel 1 can be two-dimensionally detected by sequentially changing from applying a scanning voltage to one detector wire 43 to applying a scanning voltage to another detector wire 43 (i.e., by scanning through the plurality of detector wires 43).

(Main Advantages of the Liquid Crystal Display Panel)

Thus, the liquid crystal display panel 1 includes touch switches 50 each constituted by (i) a switch electrode 52 of the active substrate 12 and (ii) switch PS electrodes 51 of the counter substrate 11 so as to conduct electricity when the active substrate 12 or the counter substrate 11 is pressed.

Pressing a region on the touch surface, which is the front surface of the counter substrate 11 or the back surface of the active substrate 12 (i.e., that surface of the active substrate 12 which faces the backlight 2), with a finger, a stylus, or the like causes the region thus pressed to be locally curved. In the region thus curved, contact between the transparent electrode 27, formed at the apical end of each of the switch PS electrodes 51, and the switch electrode 52 brings the switch PS electrodes 51 and the switch electrode 52 into electrical conduction with each other. This allows each of the touch switches 50 to function as a sensor to detect a place where there is electrical conduction (i.e., a place pressed).

Furthermore, the liquid crystal display panel 1 includes both the reflection coatings 39, which reflect infrared light, and the reflection coatings 38, which reflect infrared light, the reflection coatings 39 being provided in the active substrate 12 with a switch electrode 52 stacked on a corresponding one of the reflection coatings 38, the reflection coatings 39 being provided in the counter substrate 11 with switch PS electrodes 51 stacked on a corresponding one of the reflection coatings 39.

This allows infrared light let in through the surface (apical surface) of each switch PS electrode 51 of the counter substrate 11 before the counter substrate 11 and the active substrate 12 are placed opposite each other to be reflected by the reflection coatings 38. Therefore, by measuring the spectrum of light reflected by the reflection coatings 38, an inspection can be carried out as to the presence or absence, on the surface (apical surface) of any switch PS electrode 51, of a residue of the alignment film 21, i.e., an element that causes faulty electrical conduction between that switch PS electrode 51 and the corresponding switch electrode 52 of the active substrate 12.

Furthermore, infrared light let in through the front surface of each switch electrode 52 of the active substrate 12 before the counter substrate 11 and the active substrate 12 are placed opposite each other can be reflected by the reflection coatings 39. Therefore, by measuring the spectrum of light reflected by the reflection coatings 39, an inspection can be carried out as to the presence or absence, on the front surface of any switch electrode 52, of a residue of the alignment film 32, i.e., an element that causes faulty electrical conduction between that switch electrode 52 and the corresponding switch PS electrodes 51 of the counter substrate 11.

Since the liquid crystal display panel 1 includes both the reflection coatings 38 and the reflection coatings 39, an inspection can be carried out on both the surface of each switch electrode 51 and the front surface of each switch electrode 52 as to the presence or absence of a residue of the alignment film 21 or 32, i.e., an element that causes faulty electrical conduction between a switch PS electrode 51 and a switch electrode 52.

This makes it possible to more efficiently and more surely check the presence or absence of an element that causes a failure to occur in a touch switch 50, as compared to the case of a visual check made with a microscope.

Alternatively, the liquid crystal display panel 1 may be configured to include at least either the reflection coatings 38 or the reflection coatings 39. This allows light let in through the surface of each switch PS electrode 51 or each switch electrode 52 before the active substrate 12 and the counter substrate 11 are placed opposite each other to be reflected by at least either the reflection coatings 38 or the reflection coatings 39.

Therefore, by measuring the spectrum of light reflected by the reflection coatings 38 or the reflection coatings 39, an inspection can be carried out as to the presence or absence, on the surface of any switch PS electrode 51 or any switch electrode 52, of a residue of the alignment film 21 or 32 that causes faulty electrical conduction between a switch PS electrode 51 and a switch electrode 52.

This makes it possible to more efficiently and more surely check the presence or absence of a residue of the alignment film 21 or 32 that causes a failure to occur in a touch switch 50, as compared to the case of a visual check made with a microscope.

Further, the switch electrodes 52 of the active substrate 12 include transparent electrodes. That is, the pixel electrodes 15 of the active substrate 12 are transparent electrodes formed in the same step as that executed in forming the transparent electrodes 52 constituting the switch electrodes 52.

This allows the switch electrodes 52 to be formed in the same step as that executed in forming the pixel electrodes 15, which are generally formed in one of the liquid crystal display panel substrates, i.e., in the active substrate 12.

This eliminates the need to set up a step solely for forming the switch electrodes 52, thus making it possible to prevent a rise in manufacturing cost.

Meanwhile, the switch PS electrodes 51 of the counter substrate 11 include the transparent electrode 27. That is, the transparent electrode 27 of the counter substrate 11 serves as a common electrode formed in the same step as that executed in forming the transparent electrode 27 constituting the switch PS electrodes 51.

This allows the transparent electrode 27 of the switch PS electrodes 51 to be formed in the same step as that executed in forming the common electrode, which is generally formed in the other one of the liquid crystal display panel substrates, i.e., in the counter substrate.

This eliminates the need to set up a step solely for forming the transparent electrode 27 of the switch PS electrodes 51, thus making it possible to prevent a rise in manufacturing cost.

Although the present embodiment has been described on the assumption that the TFT 16 and detector TFT 53 of each pixel 5 are connected to the same source wire 14, the present embodiment may also be configured by providing a source wire 14 to which the detector TFT 53 is connected, separately from a source wire 14 to which the TFT 16 is connected.

By thus providing a source wire 14 to which the detector TFT 53 is connected, separately from a source wire 14 to which the TFT 16 for controlling driving of the pixel 5 is connected, detection of the position of an area touched can be carried out independently of control of drive of the pixel 5. This brings about improvement in detection accuracy.

Although the present embodiment has been described on the assumption that a single touch switch 50 is provided in each single pixel 5, this does not imply any limitation. Alternatively, the present embodiment may also be configured such that a touch switch 50 is provided each of (i) the pixels 5 provided with the respective colored layers 26R, (ii) the pixels 5 provided with the respective colored layers 26G, or (iii) the pixels 5 provided with the respective colored layers 26B. Alternatively, the present embodiment may also be configured such that a single touch switch 50 is provided in each of those pixels 5 arbitrarily chosen.

Although the present embodiment has been described on the assumption that the number of switch PS electrodes 51 in each set to be provided on each reflection coating 38 is three, this does not imply any limitation. The number of switch PS electrodes 51 to be provided on each reflection coating 38 may be one, two, or more than three.

However, as mentioned above, providing a plurality of, e.g., three, switch PS electrodes 51 for each separate reflection coating 38 makes it possible to disperse a load that is applied to the switch PS electrodes 51 when the switch PS electrodes 51 are pressed against the switch electrode 52. This makes it possible to prevent destruction of (i) the switch PS electrodes 51, (ii) the reflection coating 38, on which the switch PS electrodes 51 are provided, and (iii) the light-shielding layer 26M, on which the reflection coating 38 is provided.

(Overview of Steps of a Process for Fabricating a Liquid Crystal Display Panel)

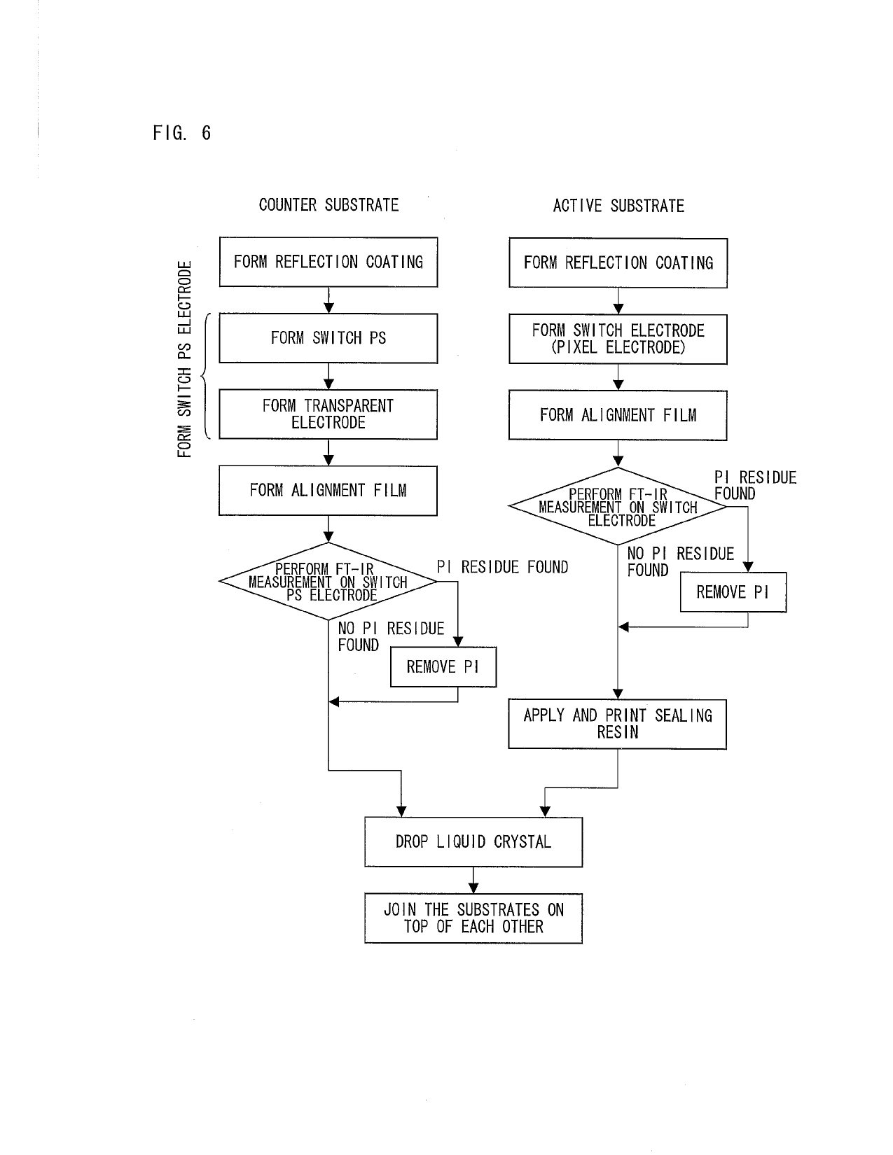

Next, steps of a process for fabricating a liquid crystal display panel 1 are schematically described with reference to FIG. 6. FIG. 6 is a flow chart explaining steps of a process for fabricating a liquid crystal display panel 1.

First, an overview of steps of a process (method) for fabricating a counter substrate 11 is given.

In a reflection coating forming step, the reflection coatings 38, which reflect infrared light, are formed on the surface of the color filter layer 26 provided on the surface of the glass substrate 25. Each of the reflection coatings 38 is formed in a region where the corresponding switch PS electrodes 51 are formed.

Next, in a switch PS electrode forming step (switching electrode forming step), each of the switch PS electrodes 51 is formed above, i.e., stacked on, a corresponding one of the reflection coatings 39 formed in the reflection coating forming step.

In the process for fabricating the counter substrate 11 according to the present embodiment, the switch PS electrode forming step includes a switch PS forming step and a transparent electrode forming step.

First, in the switch PS forming step, the switch PSs 58 are formed above, i.e., stacked on, the reflection coatings 38 formed in the reflection coating forming step.

Next, in the transparent electrode forming step, ITO is patterned to form the transparent electrode 27, which covers (i) the switch PSs 58 formed in the switch PS forming step and (ii) the color filter layer 26 formed in the color filter forming step, which is carried out before the reflection coating forming step. Thus, the common electrode and the switch PS electrodes 51 are formed.

Next, in an alignment film forming step, the alignment film 21 is formed on the surface of the transparent electrode 27 formed in the transparent electrode forming step. The alignment film 21 is formed by applying a polyimide solution onto the surface of the transparent electrode 27 and then baking the polyimide solution thus applied.

In the alignment film forming step, the alignment film 21 is formed in an area around alignment-film-21-free regions on which the alignment film 21 is selectively not deposited, the alignment-film-21-free regions being the apical surfaces (surfaces) 51a (when the counter substrate 11 is seen in plan view) of the switch PS electrodes 51 formed in the switch PS electrode forming step.

A method for selectively not forming the alignment film 21 on the apical surfaces 51a of the switch PS electrodes 51 will be described later.

Next, in a switch PS electrode inspecting step, an inspection is carried out as to the presence or absence, on the apical surface of any of the switch PS electrodes 51, which are the alignment-film-21-free regions, of a residue of the alignment film 21, i.e., polyimide (PI) formed in the alignment film forming step. The inspection as to the presence or absence of a PI residue is, for example, carried out by performing FT-IR measurement. Alternatively, the inspection as to the presence or absence of a PI residue may be carried out by determining whether or not the adhering PI exceeds an allowable amount. The switch PS electrode inspecting step will be described later in detail.

In a case where it is determined in the switch PS electrode inspecting step that there is a residue of PI on the apical surface 51a of any switch PS electrode 51, such a substrate determined to have a residue of PI then proceeds to a PI removing step.

In a case where it is determined in the switch PS electrode inspecting step that there is no residue of PI on the apical surface 51a of any switch PS electrode 51, such a substrate determined to have no residue of PI is judged as a good counter substrate 11 and then proceeds to a next step.

In the PI removing step, the substrate that has been determined to have a residue of PI on the apical surface 51a of any switch PS electrode 51 is, for example, subjected to an ashing process. Thus, the PI adhering to the apical surface 51a of the switch PS electrode 51 is removed.

The substrate finished with removal of the PI adhering to the apical surface 51a of the switch PS electrode 51 in the PI removing step is judged as a good counter substrate 11 and then proceeds to the next step.

Next, an overview of steps of a process for fabricating an active substrate 12 is given.

In a reflection coating forming step, the reflection coatings 39, which reflect infrared light, are formed on the surface of the gate insulating film 36 provided on the surface of the glass substrate 35. Each of the reflection coatings 39 is formed in a region where the corresponding switch electrode 52 is provided.

In a case where the reflection coatings 39 are made of the same material as the material of which any of the electrodes and semiconductor layers constituting the TFT 16 and the detector TFT 53 is made, the reflection coatings 39 may be formed in the same step as that executed in forming the electrode or semiconductor layer made of the same material.

In the present embodiment, a switch electrode forming step serves also as a transparent electrode forming step. In the switch electrode forming step, ITO is patterned to form the switch electrodes 52, which cover the reflection coatings 39 formed in the reflection coating forming step. In the switch electrode forming step, the pixel electrodes 15 are also formed on the surface of the interlayer insulating film 37 stacked on the gate insulating film 36.

Next, in an alignment film forming step, the alignment film 32 is formed on the surfaces of the pixel electrodes 15 formed in the switch electrode forming step and on the surface of the interlayer insulating film 37. The alignment film 32 is formed by applying a polyimide solution onto the surfaces of the pixel electrodes 15 and the surface of the interlayer insulating film 37 and then baking the polyimide solution thus applied.

In the present embodiment, the alignment film forming step for forming an alignment film of the active substrate 12 includes a PI removing step.

In the PI removing step, the alignment film 32, i.e., PI deposited on the surfaces 52a of the switch electrodes 52 is removed, for example, by carrying out an ashing process. The surfaces 52a (when the active substrate 12 is seen in plan view) of the switch electrodes 52 formed in the switch electrode forming step serve as alignment-film-32-free regions on which the alignment film 32 is selectively not deposited.

Thus, in the alignment film forming step, the alignment film 32 is formed in an area around the alignment-film-32-free regions. A method for removing PI from the surfaces 52a of the switch electrodes 52 will be described later.

Next, in a switch electrode inspecting step, an inspection is carried out as to the presence or absence, on the surface 52a of any of the switch electrodes 52, which are the alignment-film-32-free regions, of a residue of the alignment film 32, i.e., PI formed in the alignment film forming step. The inspection as to the presence or absence of a PI residue is, for example, carried out by conducting FT-IR measurement. Alternatively, the inspection as to the presence or absence of a PI residue may be carried out by determining whether or not the adhering PI exceeds an allowable amount. The switch electrode inspecting step will be described later in detail.

In a case where it is determined in the switch electrode inspecting step that there is a residue of PI on the surface 52a of any switch electrode 52, such a substrate determined to have a residue of PI then proceeds to the PI removing step.

In a case where it is determined in the switch electrode inspecting step that there is no residue of PI on the surface 52a of any switch electrode 52, such a substrate determined to have no residue of PI is judged as a good active substrate 12 and then proceeds to a next step.

In the PI removing step, the substrate that has been determined to have a residue of PI on the surface 52a of any switch electrode 52 is, for example, subjected to an ashing process. Thus, the PI adhering to the surface 52a of the switch electrode 52 is removed.

The substrate finished with removal of the PI adhering to the surface 52a of the switch electrode 52 in the PI removing step is judged as a good counter substrate 12 and then proceeds to the next step.

Next, in a seal forming step, a sealing resin is applied and printed onto the completed active substrate 12. Then, liquid crystals are allowed to drip onto the active substrate 12, and the active substrate 12 is bonded to the completed counter substrate 11. Then, by disposing a polarizing plate to each of the outer surfaces of the counter substrate 11 and the active substrate 12, the liquid crystal display panel 1 is completed. By providing the liquid crystal display panel 1 with a driving circuit, the backlight 2, and the like, a liquid crystal display device is completed.

Next, a method for fabricating a counter substrate 11 and a method for fabricating an active substrate 12 are described in detail.

(Method for Fabricating a Counter Substrate)

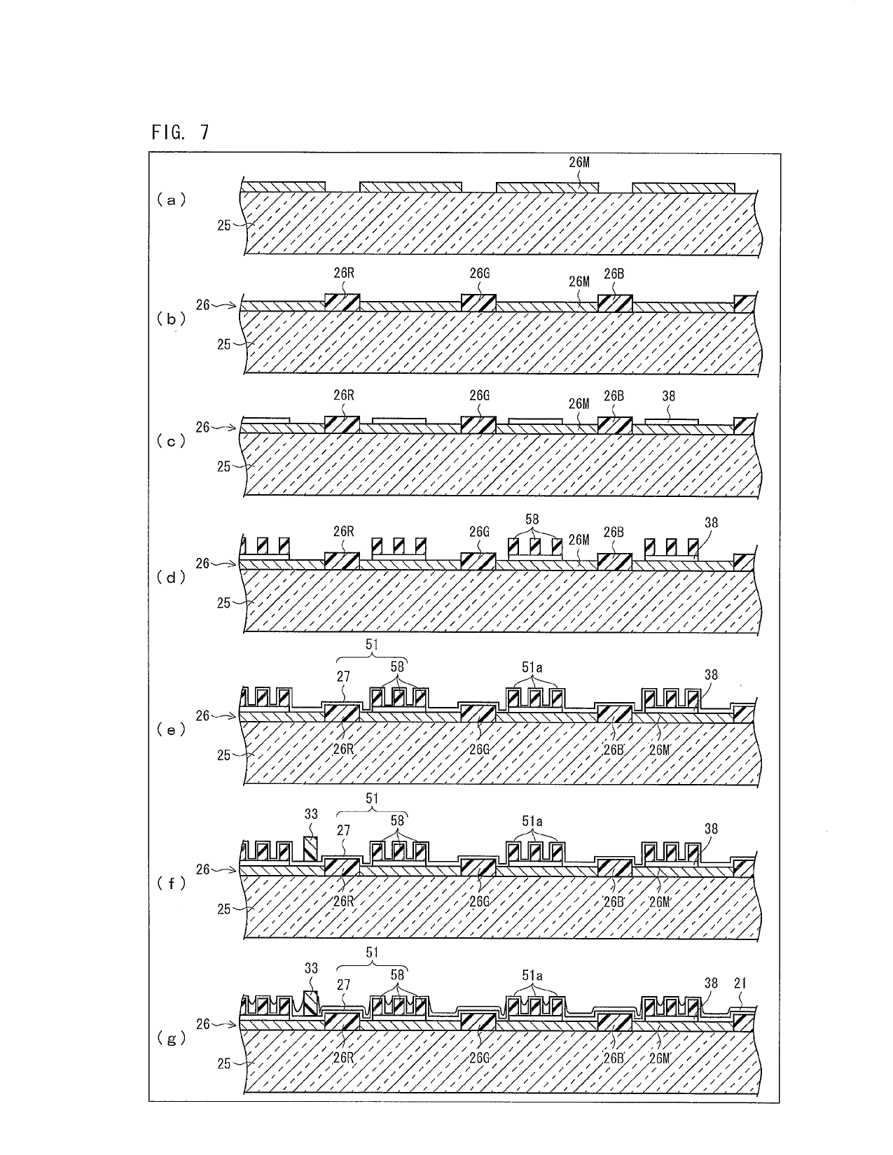

First, a method for fabricating a counter substrate 11 is described with reference to (a) through (f) of FIG. 7.

(a) through (f) of FIG. 7 are diagrams showing a method for fabricating a counter substrate 11.

First, in a color filter layer forming step, the light-shielding layer 26M and the colored layers 26R, 26G, and 26B are formed on the glass substrate 25.

As shown in (a) of FIG. 7, the light-shielding layer 26M is formed in a predetermined pattern on the glass substrate 25.

For example, the light-shielding layer 26M can be formed by applying a black resin material onto a surface of the glass substrate 25 and then removing an unnecessary portion of the black resin material by photolithography.

Next, as shown in (b) of FIG. 7, the colored layers 26R, 26G, and 26B are formed within light-shielding-layer-26M-free regions, i.e., regions which will become pixels 5.

First, a color resist containing a colored layer material is applied onto the glass substrate 25 and is then irradiated with ultraviolet light via a photo mask having a predetermined pattern of openings. This cures portions of the color resist that correspond to the predetermined pattern of openings, thereby making these portions insoluble. Next, unnecessary portions of the color resist that were not cured are removed by a developer. Then, the color resist thus patterned without being removed is cured by baking.

This step is executed separately for red, green, and blue colored layer materials. As a result, the colored layers 26R, 26G, and 26B are formed.

Thus, the color filter layer 26 is formed.

It should be noted that a method for forming the color filter layer 26 is not limited to that described above, but can be any publicly known method.

Next, as shown in (c) of FIG. 7, each of the reflection coatings 38 is formed on a surface of the light-shielding layer 26M of the color filter layer 26 (the reflection coating forming step). For example, each of the reflection coatings 38 can be formed by forming, by a sputtering method on the surface of the light-shielding layer 26M, a thin film of a metal material of which the reflection coatings 38 are made.

Next, as shown in (d) of FIG. 7, the switch PSs 58 are formed on the surfaces of the reflection coatings 38 (the switch PS electrode forming step).

First, a resist containing a transparent resin material of which the switch PSs 51 are made is applied onto the surfaces of the reflection coatings 38 and the surface of the color filter layer 26.

Next, the resist is irradiated with ultraviolet light via a photo mask having a predetermined pattern of openings. This cures portions of the resist that correspond to the predetermined pattern of openings, thereby making these portions insoluble. Next, unnecessary portions of the resist that were not cured are removed by a developer. Then, the resist thus patterned without being removed is cured by baking.

Thus, the switch PSs 58 are formed on the surfaces of the reflection coatings 38.

It should be noted that a material of which the switch PSs 58 are made is not limited to the transparent resin material, but may be any of the color resists used to form the colored layers 26R, 26G, and 26B.

Next, as shown in (e) of FIG. 7, the transparent electrode 27, which serves as a common electrode, is formed so as to cover the color filter layer 26, the reflection coatings 38, and the switch PSs 58 (the transparent electrode forming step).

For example, the transparent electrode 27 can be formed by forming, by a sputtering method, a thin film of ITO of which the transparent electrode 27 is made.

Thus, the common electrode and the switch PS electrodes 51, each of which is constituted by a switch PSs 58 and the transparent electrode 27, are formed.

Next, as shown in (f) of FIG. 7, the spacers 33, which serve as main PSs, are formed on the surface of the transparent electrode 27 so as to be located above the light-shielding layer 26M (spacer forming step).

First, a resist containing a resin material of which the spacers 33 are made is applied onto the surface of the transparent electrode 27.

Next, the resist is irradiated with ultraviolet light via a photo mask having a predetermined pattern of openings. This cures portions of the resist that correspond to the predetermined pattern of openings, thereby making these portions insoluble. Next, unnecessary portions of the resist that were not cured are removed by a developer. Then, the resist thus patterned without being removed is cured by baking.

Thus, the spacers 33 are formed on the surface of the transparent electrode 27 so as to be located above the light-shielding layer 26M.

Next, as shown in (g) of FIG. 7, the alignment film 21 is formed on the surface of the transparent electrode 27 (the alignment film forming step). A polyimide solution (PI solution) of which the alignment film 21 is made is applied onto the surface of the transparent electrode 27 and is then cured by baking. The film thus cured serves as the alignment film 21.

It should be noted here that the switch PS electrodes 51 and the spacers 33 are each in the shape of a protrusion with a certain degree of height. Such a shape of the switch PS electrodes 51 and the spacers 33 is not completely surpassed by polyimide of which the alignment film 21 is made. Accordingly, polyimide cures while no polyimide film is formed on the apical surface of any switch PS electrode 51 (surface facing the switch electrode 52) or the apical surface of any spacer 33 (surface that make contact with the active substrate 12). In the present embodiment, for example, each of the switch PS electrodes 51 has a height of 2.5 μm and each of the spacers 33 has a height of approximately 3 μm.

Thus, the alignment film 21 is formed on the surface of the transparent electrode 27, except for the apical surfaces of the switch PS electrodes 51 and the apical surfaces of the spacers 33.

This allows the apical surfaces 51a of the switch PS electrodes 51 to serves as the alignment-film-21-free regions where the alignment film 21 is selectively not formed, i.e., allows the apical surfaces 51a of the switch PS electrodes 51 to serve as regions where PI is not formed. Thus, the counter substrate 11 is formed.

Furthermore, a PI removing step may be added in order to more surely remove a residue of PI from the apical surface 51a of each switch PS electrode 51.

The following describes a specific example of the PI removing step.

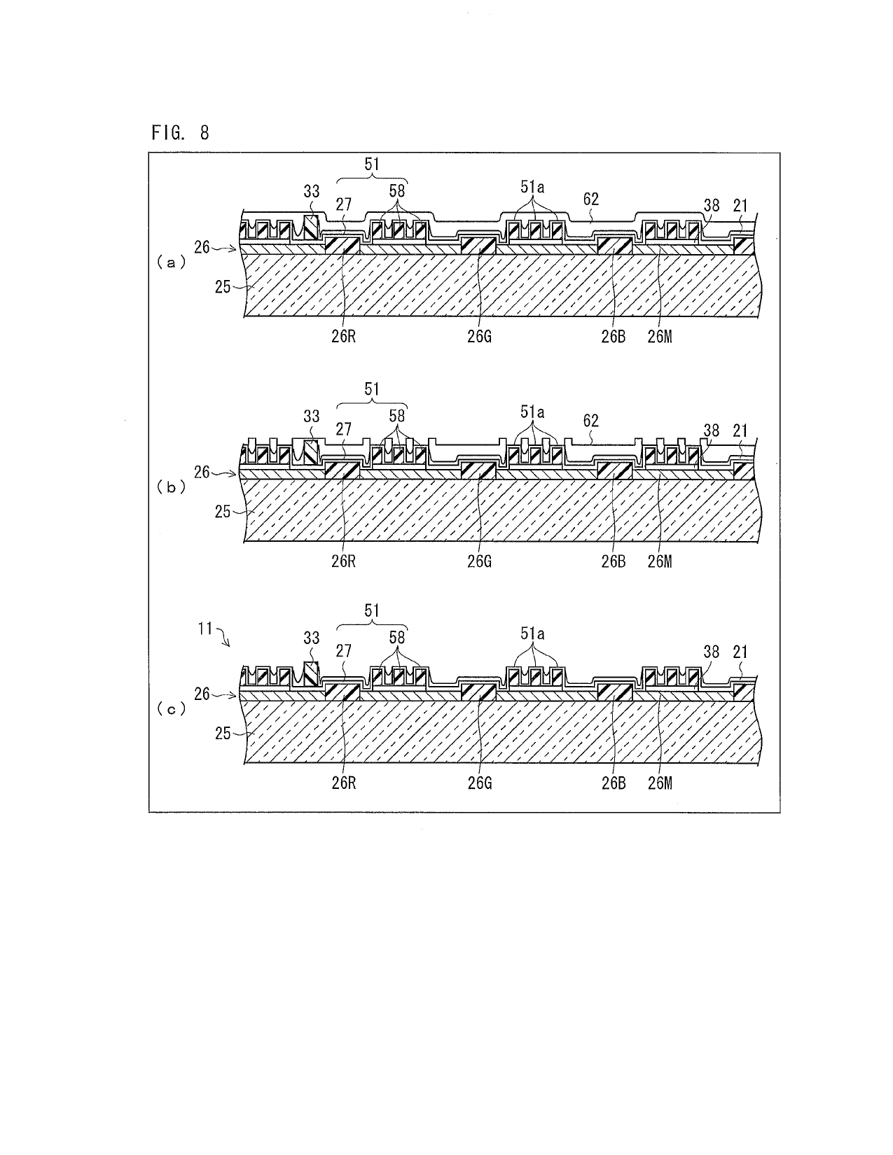

(a) through (c) of FIG. 8 are diagrams explaining a method for removing the alignment film 21 from the apical end of each switch PS electrode.

As shown in (a) of FIG. 8, after the alignment film 21 is formed, the resist 62 is deposited on the entire surface of the counter substrate 11 so as to also cover the apical surfaces 51a of the switch PS electrodes 51.

Next, as shown in (b) of FIG. 8, portions of the resist 62 that are present on the apical surfaces 51a of the switch PS electrodes 51 are removed.

Next, the apical surfaces 51a of the switch PS electrodes 51 thus exposed are subjected to ashing by oxygen plasma.

Then, as shown in (c) of FIG. 8, the remaining resist 62 is washed away. This completes the counter substrate 11 in finished with removal of a residue of PI on the apical surface 51a of each switch PS electrode 51.

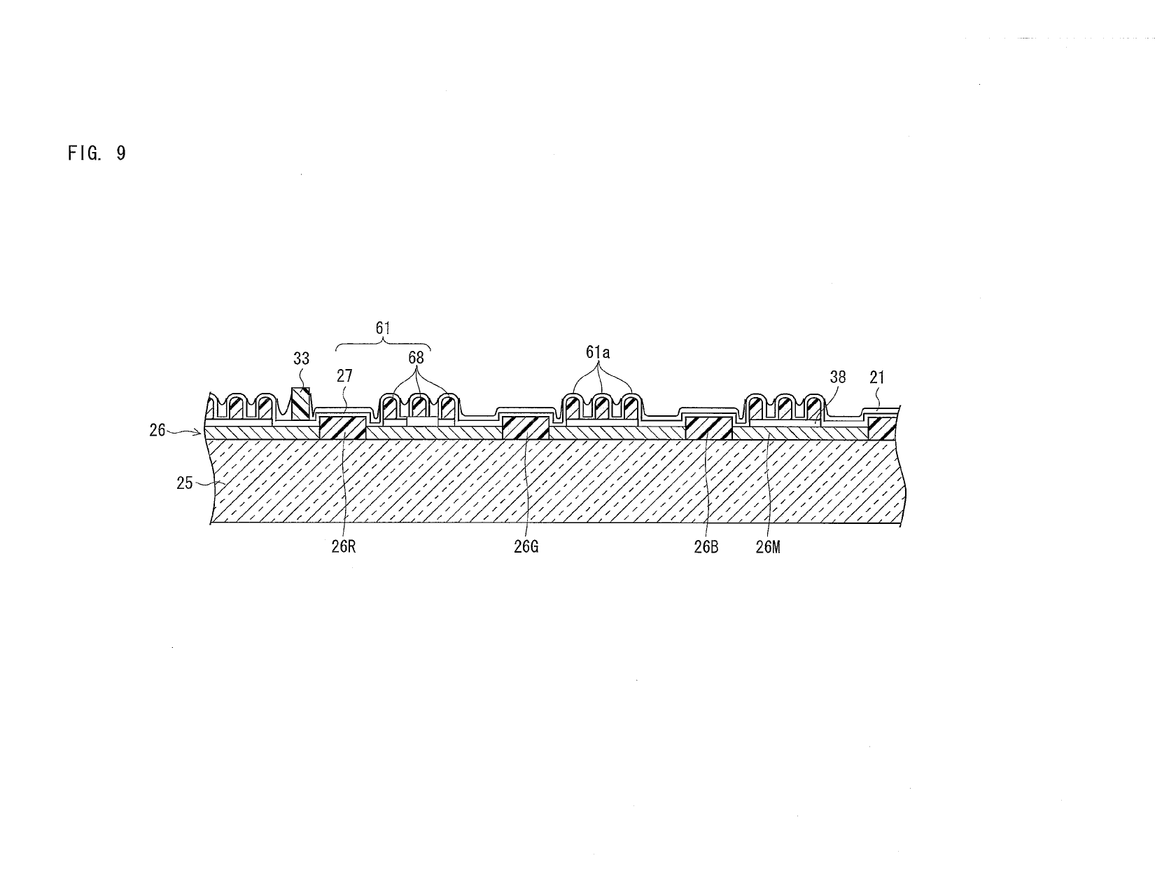

Each switch PS electrode may be configured to have a shape shown in FIG. 9 so that no alignment film is formed on the apical surface of each switch PS electrode.

FIG. 9 is a diagram showing a modification of each switch PS electrode.

Further, as shown in FIG. 9, each switch PS electrode (switching electrode, electrode of the other substrate, second switching electrode) 61 has its apical surface (alignment-film-free region) 61a in the shape of a convex surface. This shape makes it easy to shed the alignment film 21.

After the switch PSs 58 are formed on the surfaces of the reflection coatings 38 as described with reference to (d) of FIG. 7, a thermal treatment step is additionally executed in which the switch PSs 58 thus formed are heated.

In the thermal treatment step, for example, heat of approximately 220° C. is applied to the switch PSs 58. This softens and deforms peripheries of the apical surfaces of the switch PSs 58. This causes the apical surfaces of the switch PSs 58 to be rounded off to be curved outwards. This forms switch PSs 68 of FIG. 9.

Next, as shown in (e) of FIG. 7, the transparent electrode 27, which serves as a common electrode, is formed so as to cover the color filter layer 26, the reflection coatings 38, and the switch PSs 58. This causes portions of the transparent electrode 27 that are stacked on the apical surfaces of the switch PSs each curved outwards to be also curved outwards. This causes switch PS electrodes 61 to be formed each of which has its apical surface 61a in the shape of a convex surface as shown in FIG. 8.

The subsequent steps are similar to those described with reference to (f) through (g) of FIG. 7, and as such, are not described below.

This is how a counter substrate 11 can be formed which is provided with switch PS electrodes 61 each having its apical surface 61a in the shape of a convex surface.

As described above, a method for fabricating a counter substrate 11 includes: (a) the reflection coating forming step of forming the reflection coatings 38 that reflect infrared light; and (b) the switch PS electrode forming step of forming, above each separate one of the reflection coatings 38 formed in the reflection coating forming step, a plurality of switch PS electrodes 51 or plural sets of switch PS electrodes 51 each of which forms a touch switch 50 with a corresponding one of the plurality of switch electrodes 52 or with a corresponding one of the plural sets of switch electrodes 52 of the active substrate 12, and each of which makes electrical conduction with the corresponding one of the plurality of switch electrodes 52 or with the corresponding one of the plural sets of switch electrodes 52 when either the counter substrate 11 or the active substrate 12 is pressed against the other with the counter substrate 11 placed opposite the active substrate 12.

According to this arrangement, in the switch PS electrode forming step, the plurality of switch PS electrodes 51 or the plural sets of switch PS electrodes 51 are formed above each separate one of the reflection coatings 38 formed in the reflection coating forming step. This makes it possible to fabricate a counter substrate 11 that allows infrared light let in through the apical surface (alignment-film-free region) 51a of each switch PS electrode 51 to be reflected by the reflection coatings 38.

This makes it possible to fabricate a counter substrate 11 that makes it possible that by measuring the spectrum of light reflected by the reflection coatings 38, an inspection can be carried out as to the presence or absence, on the apical surface 51a of any switch PS electrode, of a residue (PI residue) of the alignment film 21 that causes faulty electrical conduction with the corresponding switch electrode 52 of the active substrate 12.

This makes it possible to fabricate a counter substrate 11 that makes it possible to more efficiently and more surely check the presence or absence of an element that causes a failure to occur in any one of those switches, as compared to the case of a visual check made with a microscope.

The method for fabricating the counter substrate 11 further includes an alignment film forming step of forming the alignment film 21 in an area around alignment-film-21-free regions on which the alignment film 21 is selectively not deposited, the alignment-film-21-free regions being the apical surfaces 51a of the switch PS electrodes 51 formed in the switching electrode forming step.

According to this arrangement, the alignment film 21, which may cause faulty electrical conduction with a switch electrode 52 of the active substrate 12 placed opposite the counter substrate 11, can be formed in the counter substrate 11 without being formed on the apical surfaces 51a of the switch PS electrodes 51. This makes it possible to fabricate a counter substrate 11 provided with switch PS electrodes 51 that prevent faulty electrical conduction from occurring.

(Main Advantages of the Counter Substrate 11)

Next, the following describes main advantages of the counter substrate 11 that constitutes the liquid crystal display panel 1 by being placed opposite the active substrate 12 with a liquid crystal layer 10 sandwiched between the counter substrate 11 and the active substrate 12.

The counter substrate 11 includes (i) a plurality of switch PS electrodes 51 or plural sets of switch PS electrodes 51 each of which forms a touch switch 50 with a corresponding one of the plurality of switch electrodes 52 or with a corresponding one of the plural sets of switch electrodes 52 of the active substrate 12, the plurality of switch PS electrodes 51 or the plural sets of switch PS electrodes 51 being each disposed so as to make electrical conduction with the corresponding one of the plurality of switch electrodes 52 or with the corresponding one of the plural sets of switch electrodes 52 when either the counter substrate 11 or the active substrate 12 is pressed against the other with the counter substrate 11 placed opposite the active substrate 12, and (ii) reflection coatings 38 which reflect infrared light, the reflection coatings 38 being disposed below each separate one of the plurality of switch PS electrodes 51 or below each separate one of the plural sets of switch PS electrodes 51.

In the counter substrate 11 thus configured, the plurality of switch PS electrodes 51 or the plural sets of switch PS electrodes 51 forms a touch switch 50 with a corresponding one of the plurality of switch electrodes 52 or with a corresponding one of the plural sets of switch electrodes 52 of the active substrate 12 when the counter substrate 11 is placed opposite the active substrate 12. Moreover, when either the counter substrate 11 or the active substrate 12 is pressed against the other, the touch switch 50 conducts electricity. This allows the touch switch 50 to function as a sensor to detect the position of such electrical conduction.

Furthermore, in the counter substrate 11, the reflection coatings 38, which reflect infrared light, are disposed below each separate one of the plurality of switch PS electrodes 51 or below each separate one of the plural sets of switch PS electrodes 51. This allows infrared light let in through the apical surfaces (surfaces) 51a of the switch PS electrodes 51 before the counter substrate 11 is placed opposite the active substrate 12 to be reflected by the reflection coatings 38. Therefore, by measuring the spectrum of light reflected by the reflection coatings 38 with use of a measuring device or the like, an inspection can be carried out as to the presence or absence, on the apical surface (surface) 51a of any switch PS electrode 51, of a residue of the alignment film 21 that causes faulty electrical conduction with any of the switch electrodes 52 of the active substrate 12.

This makes it possible to more efficiently and more surely check the presence or absence of an element that causes a failure to occur in the touch switch 50, as compared to the case of a visual check made by an inspector using a microscope.

Further, the counter substrate 11 further includes the alignment film 21 formed so that the apical surfaces 51a of the switch PS electrodes 51 serve as alignment-film-free regions on which the alignment film 21 is selectively not provided. When the counter substrate 11 is seen in plan view, each of the reflection coatings 38 appears to be overlapping a corresponding one(s) of the alignment-film-21-free regions.

According to the foregoing configuration, when the counter substrate 11 is seen in plan view, each of the reflection coatings 38 appears to be overlapping a corresponding one(s) of the alignment-film-21-free regions (i.e., the apical surfaces 51a of the switch PS electrodes 51). This allows infrared light emitted onto the alignment-film-21-free regions to be reflected by the reflection coatings 38.

Therefore, by measuring the spectrum of light reflected by the reflection coatings 38 with use of a measuring device or the like, an inspection can be carried out as to the presence or absence, within the alignment-film-21-free regions, of a PI residue which is a residue of the alignment film 21. This makes it possible to more efficiently and more surely check the presence or absence, on the apical surface 51a of any switch PS electrode 51, a PI remnant that causes a failure to occur in the touch switch 50, as compared to the case of a visual check made with a microscope.

Each of the switch PS electrodes 51 of the counter substrate 11 is constituted by (i) the transparent electrode 27 and (ii) a switch PS (structure) 58 having a protruding shape with the transparent electrode 27 stacked on the switch PS (structure) 58.

That is, each of the switch PS electrodes 51 is constituted by (i) a switch PS 58 having a protruding shape and (ii) the transparent electrode 27 stacked on the switch PS 58, and as such, has a protruding shape, too. This makes possible to surely made electrical conduction between each of the plurality of switch PS electrodes 51 or each of the plural sets of switch PS electrodes 51 and the corresponding one of the plurality of switch electrodes 52 or the corresponding one of the plural sets of switch electrodes 52 of the active substrate 12 when either the counter substrate 11 or the active substrate 12 is pressed against the other with the counter substrate 11 placed opposite the active substrate 12.

(Method for Fabricating an Active Substrate)

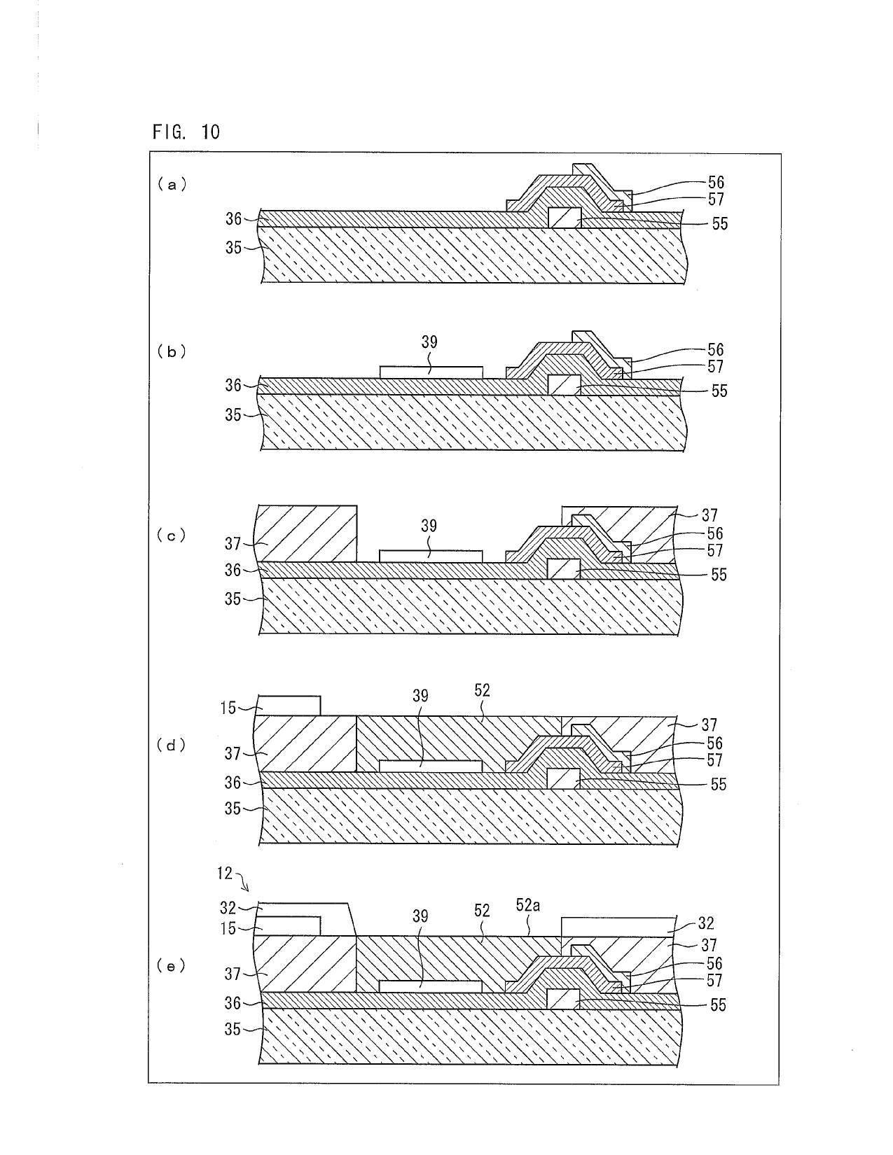

Next, a method for fabricating an active substrate 12 is described with reference to (a) through (e) of FIG. 10.

(a) through (e) of FIG. 10 are diagrams explaining a method for fabricating an active substrate 12.

As shown in (a) of FIG. 10, the gate electrode 55 is formed on the surface of the glass substrate 35, for example, by a sputtering method. In the same step as that executed in forming the gate electrode 55, the detector wires 43, the gate wires 13, and the gate electrode 17 that constitutes the TFT 16 for driving the pixel 5 are also formed on the surface of the glass substrate 35.

Then, the gate insulating film 36 is formed on the surface of the glass substrate 35, for example, by a sputtering method so as to cover the gate electrode 55.

Then, the semiconductor layer 57 is formed on the surface of the gate insulating film 36, for example, by a sputtering method so as to cover the gate electrode 55. In the same step as that executed in forming the semiconductor layer 57, the semiconductor layer 34 that constitutes the TFT 16 is also formed.

Then, the source electrode 56 is formed on the gate insulating film 36, for example, by a sputtering method so as to cover part of the semiconductor layer 57. In the same step as that executed in forming the source electrode 56, the source wires 14, the source electrode 18, and the drain electrode 19 are also formed.

Next, as shown in (b) of FIG. 10, the reflection coatings 39 of a predetermined pattern are formed on the surface of the gate insulating film 36, for example, by a sputtering method (reflection coating forming step).

In a case where the reflection coatings 39 are made of the same metal material as the metal material of which the source electrode 56, the semiconductor layer 57, or the like is made, the reflection coatings 39 may be formed in the same step as that executed in forming the source electrode 56 or in the same step as that executed in forming the semiconductor layer 57.

Next, as shown in (c) of FIG. 10, the interlayer insulating film 37 of a predetermined pattern is formed. The interlayer insulating film 37 is patterned, for example, by a CVD method or a spin coating method so that parts of the interlayer insulating film 37 that are formed on regions where the switch electrodes 52 are formed are removed. This causes the reflection coatings 39 to be exposed.

Then, the contact hole 23 (not shown) through which the drain electrode 19 of the TFT 16 and the pixel electrode 15 are connected to each other is formed in the interlayer insulating film 37.

Next, as shown in (d) of FIG. 10, the pixel electrodes 15 and the switch electrodes 52 are formed (switch electrode forming step).

For example, ITO is patterned into a predetermined pattern by a sputtering method. Thus, the pixel electrodes 15 are formed on the surface of the interlayer insulating film 37, and the switch electrodes 52 are formed in regions where the switch electrode 52 are formed, i.e., in regions where the interlayer insulating film 37 has been removed so that the reflection coatings 39 are exposed, so as to cover the reflection coatings 39.

Next, as shown in (e) of FIG. 10, the alignment film 32 is formed on the surfaces of the pixel electrodes 15 and on the surface of the interlayer insulating film 37 (alignment film forming step).

A polyimide solution of which the alignment film 32 is made is applied onto the surface of the interlayer insulating film 37 so as to cover the pixel electrodes 15, and is then cured by baking.

Next, the polyimide deposited on the switch electrodes 52 is removed (PI removing step). The polyimide deposited on the switch electrodes 52 may be removed by an ashing process as described with reference to (a) through (c) of FIG. 8 or may be removed by any of the other publicly-known techniques.

This allows the surfaces 52a of the switch electrodes 52 to serve as alignment-film-32-free regions where the alignment film 32 is selectively not formed.

This is how an active substrate 12 is fabricated.

Next, after the undermentioned switch electrode inspecting step, the liquid crystal layer 10 is formed by bonding the completed active substrate 12 and the completed counter substrate 11 bonded to each other and injecting liquid crystals into a space between the active substrate 12 and the counter substrate 11. Then, by attaching a polarizing plate to each of the outer surfaces of the counter substrate 11 and the active substrate 12, the liquid crystal display panel 1 is formed.

By providing the liquid crystal display panel 1 with various driving circuits and wires and connecting the backlight 2 to the liquid crystal display panel 1, the liquid crystal display device 3 is formed.

As described above, a method for fabricating an active substrate 12 includes: (a) the reflection coating forming step of forming the reflection coatings 39 that reflect infrared light; and (b) the switch electrode forming step of forming, above each separate one of the reflection coatings 39 formed in the reflection coating forming step, a plurality of switch electrodes 52 or plural sets of switch electrodes 52 each of which forms a touch switch 50 with a corresponding one of the plurality of switch PS electrodes 51 or with a corresponding one of the plural sets of switch PS electrodes 51 of the counter substrate 11, and each of which makes electrical conduction with the corresponding one of the plurality of switch PS electrodes 51 or with the corresponding one of the plural sets of switch PS electrodes when either the active substrate 12 or the counter substrate 11 is pressed against the other with the active substrate 12 placed opposite the counter substrate 11.

According to this arrangement, in the switch PS electrode forming step, the plurality of switch electrodes 52 or the plural sets of switch electrodes 52 are formed above each separate one of the reflection coatings 39 formed in the reflection coating forming step. This makes it possible to fabricate an active substrate 12 that allows infrared light let in through the surface 52a of each switch electrode 52 to be reflected by the reflection coatings 39.

This makes it possible to fabricate an active substrate 12 that makes it possible that by measuring the spectrum of light reflected by the reflection coatings 39, an inspection can be carried out as to the presence or absence, on the surface 52a of any switch electrode 52, of a residue (PI residue) of the alignment film 21 that causes faulty electrical conduction with the corresponding switch PS electrode 51 of the counter substrate 11.

This makes it possible to fabricate an active substrate 12 that makes it possible to more efficiently and more surely check the presence or absence of an element that causes a failure to occur in any touch switch 50, as compared to the case of a visual check made with a microscope.

The method for fabricating the active substrate 12 further includes an alignment film forming step of forming the alignment film 32 in an area around alignment-film-32-free regions on which the alignment film 32 is selectively not deposited, the alignment-film-32-free regions being the surfaces 52a of the switch electrodes 52 formed in the switch electrode forming step.

According to this arrangement, the alignment film 32, which may cause faulty electrical conduction with a switch PS electrode 51 of the counter substrate 11 placed opposite the active substrate 12, can be formed in the active substrate 12 without being formed on the surfaces 52a of the switch electrodes 52. This makes it possible to fabricate an active substrate 12 provided with switch electrodes 52 that prevent faulty electrical conduction from occurring.

(Main Advantages of the Active Substrate 12)

Next, the following describes main advantages of the active substrate 12 that constitutes the liquid crystal display panel 1 by being placed opposite the counter substrate 11 with the liquid crystal layer 10 sandwiched between the active substrate 12 and the counter substrate 11.

The active substrate 12 includes (i) a plurality of switch electrodes 52 or plural sets of switch electrodes 52 each of which forms a touch switch 50 with a corresponding one of the plurality of switch PS electrodes 51 or with a corresponding one of the plural sets of switch PS electrodes of the counter substrate 11, the plurality of switch electrodes 52 or the plural sets of switch electrodes 52 being each disposed so as to make electrical conduction with the corresponding one of the plurality of switch PS electrodes 51 or with the corresponding one of the plural sets of switch PS electrodes 51 when either the active substrate 12 or the counter substrate 11 is pressed against the other with the active substrate 12 placed opposite the counter substrate 11, and (ii) reflection coatings 39 which reflect infrared light, the reflection coatings 39 being disposed below each separate one of the plurality of switch electrodes 52 or below each separate one of the plural sets of switch electrodes 52.

In the active substrate 12 thus configured, the plurality of switch electrodes 52 or the plural sets of switch electrodes 52 forms a touch switch 50 with a corresponding one of the plurality of switch PS electrodes 51 or with a corresponding one of the plural sets of switch PS electrodes 51 of the counter substrate 11 when the active substrate 12 is placed opposite the counter substrate 11. Moreover, when either the active substrate 12 or the counter substrate 11 is pressed against the other, the touch switch 50 conducts electricity. This allows the touch switch 50 to function as a sensor to detect the position of such electrical conduction.

Furthermore, in the active substrate 12, the reflection coatings 39, which reflect infrared light, are disposed below each separate one of the plurality of switch electrodes 52 or below each separate one of the plural sets of switch electrodes 52. This allows infrared light let in through the surfaces 52a of the switch electrodes 52 before the active substrate 12 is placed opposite the counter substrate 11 to be reflected by the reflection coatings 39. Therefore, by measuring the spectrum of light reflected by the reflection coatings 39 with use of a measuring device or the like, an inspection can be carried out as to the presence or absence, on the surface 52a of any switch electrode 52, of a residue of the alignment film 32 that causes faulty electrical conduction with any of the switch PS electrodes 51 of the counter substrate 11.

This makes it possible to more efficiently and more surely check the presence or absence of an element that causes a failure to occur in the touch switch 50, as compared to the case of a visual check made by an inspector using a microscope.

Further, the active substrate 12 further includes the alignment film 32 formed so that the surfaces 52a of the switch electrodes 52 serve as alignment-film-32-free regions on which the alignment film 32 is selectively not provided. When the active substrate 12 is seen in plan view, each of the reflection coatings 38 appears to be overlapping a corresponding one(s) of the alignment-film-32-free regions.

According to the foregoing configuration, when the active substrate 12 is seen in plan view, each of the reflection coatings 39 appears be overlapping a corresponding one(s) of the alignment-film-32-free regions (i.e., the surfaces of the switch electrodes 52). This allows infrared light emitted onto the alignment-film-32-free regions to be reflected by the reflection coating 39.

Therefore, by measuring the spectrum of light reflected by the reflection coating 39 with use of a measuring device or the like, an inspection can be carried out as to the presence or absence of a PI residue which is a residue of the alignment film 32 in (any of) the alignment-film-32-free region(s). This makes it possible to more efficiently and more surely check the presence or absence, on the surface 52a of any switch electrode 52, of a PI residue that causes a failure to occur in the touch switch 50, as compared to the case of a visual check made with a microscope.

(Switch PS Electrode Inspecting Step and Switch Electrode Inspecting Step)

Next, the switch PS electrode inspecting step and the switch electrode inspecting step are described below.

The inspecting step is preferably provided for both production lines in which the counter substrate 11 and the active substrate 12, respectively, are produced. However, the inspecting step may be provided for at least either of the production lines.

In the following, the step of inspecting the switch PS electrodes of a counter substrate 11 (switch PS electrode inspecting step) is described.

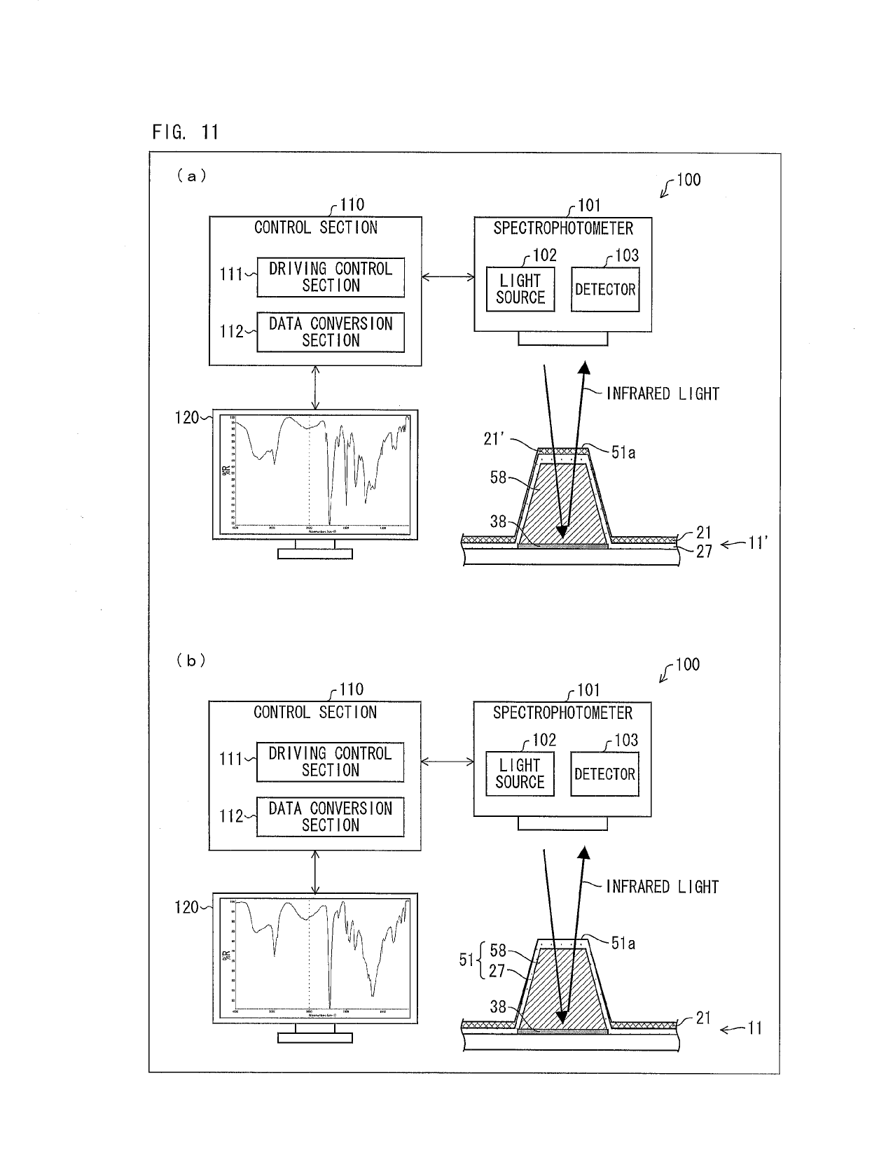

FIG. 11 is a set of diagrams (a) and (b), (a) being a diagram showing how a substrate having a PI residue on a switching electrode is inspected, (b) being a diagram showing how a substrate having no PI residue on a switching electrode is inspected.

As shown in (a) and (b) of FIG. 11, a switching electrode inspection apparatus 100 includes a spectrophotometer 101 for converting received light into a spectrum, a control section 110 for controlling driving of the switching electrode inspection apparatus 100 as a whole, and a display section 120 for displaying received spectrum data.

For example, a Fourier transform infrared spectrophotometer (FT-IR) is used as the spectrophotometer 101. For example, Avatar 370 [product name, manufactured by Thermo Fisher Scientific K.K.] or the like can be used as the Fourier transform infrared spectrophotometer.

The switching electrode inspection apparatus 100 employs a so-called FT-IR reflection method in which emitted infrared light is reflected by an external reflection film and the intensity of the light thus reflected is measured by the spectrophotometer 101.

The spectrophotometer 101 includes a light source 102 and a detector 103. The control section 110 includes a driving control section 111 and a data conversion section 112. It should be noted that the control section 110 may be provided either outside or inside of the spectrophotometer 101.

The light source 102 is an infrared light source for emitting infrared light.

The detector 103 receives reflected light obtained by externally reflecting infrared light emitted from the light source 102, and then converts the received reflected light into a spectrum. The detector 103 outputs, to the data conversion section 112 of the control section 110, the spectrum obtained by the conversion. For the detector 103, the present embodiment uses MCT (mercury-cadmium-tellurium), for example.

The driving control section 111 (i) gives the spectrophotometer 101 instructions to set conditions for driving and measurement and (ii) gives the display section 120 instructions to set conditions for driving and display.

The data conversion section 112 converts, into digital data, the spectrum outputted from the detector 103. Further, in order to cause the display section 120 to display the spectrum, the data conversion section 112 converts the spectrum into spectrum data in which a vertical axis and a horizontal axis are set. Then, the data conversion section 112 outputs, to the display section 120, the spectrum data obtained by the conversion.

Upon receiving the spectrum data outputted from the data conversions section 112, the display section 120 displays the received spectrum data on a display screen. This allows an inspector to visually identify a measured spectrum.

The present embodiment sets conditions for measurement as listed below. That is, the driving control section 111 gives the spectrophotometer 101 and the display section 120 instructions to set conditions for measurement as follows:

Mid-infrared range: 2.5 μm to 15 μm
Wave number display: 4000 cm⁻¹ to 650 cm⁻¹

Further, the conditions under which the detector 103 performs measurements are set as follows:

Resolving power during measurement: 4 cm⁻¹
Accumulated number of times: 64 times

When a counter substrate 11 comes, the light source 102 emits infrared light onto the apical surfaces 51a of the switch PS electrodes 51 of the counter substrate 11, i.e., onto the alignment-film-21-free regions (infrared light emitting step).

Next, the detector 103 receives (obtains) reflected light from the reflection coatings 38 reflecting the infrared light emitted from the light source 102, when the counter substrate 11 is seen in plan view, each of the reflection coatings 38 appearing to be overlapping a corresponding one(s) of the switch PS electrodes 51, which are in the alignment-film-21-free regions (reflected light obtaining step).

Further, the detector 103 converts the received reflected light into a spectrum (conversion-into-spectrum step).

Next, the data conversion section 112 (i) performs digital conversion on the spectrum outputted from the detector 103 and (ii) sets a vertical axis and a horizontal axis so as to cause the display section 120 to display the spectrum (conversion-into-spectrum step). Then, the data conversion section 112 outputs, to the display section 120, the spectrum on which the digital conversion has been performed and in which the vertical and horizontal axes have been set, and then the display section 120 displays the spectrum.

In this way, the display section 120 displays the spectrum of the reflected light received (obtained) by the detector 103 (displaying step).

Let it be assumed that as in the case of a counter substrate 11′ shown in (a) of FIG. 11, a PI 21′, i.e., a residue of the alignment film 21 is present on the apical surface 51a of any switch PS electrode 51 (i.e., the counter substrate 11′ is defective).

In this case, infrared light emitted from the light source 102 is (i) transmitted through the PI 21′, the transparent electrode 27 (ITO), and a switch PS 58 (acrylic) in this order, (ii) reflected by a reflection coating 38, (iii) transmitted through the switch PS 58, the transparent electrode 27, and the PI 21′ in this order, and (iv) received by the detector 103.

Thus, in a case where such a residue PI 21′ is present on the apical surface 51a of any switch PS electrode 51, the detector 103 outputs a spectrum containing a combined component of acrylic and PI.

It should be noted that since ITO does not absorb but transmits infrared light as it is, no peak appears on a spectrum that is outputted from the detector 103.

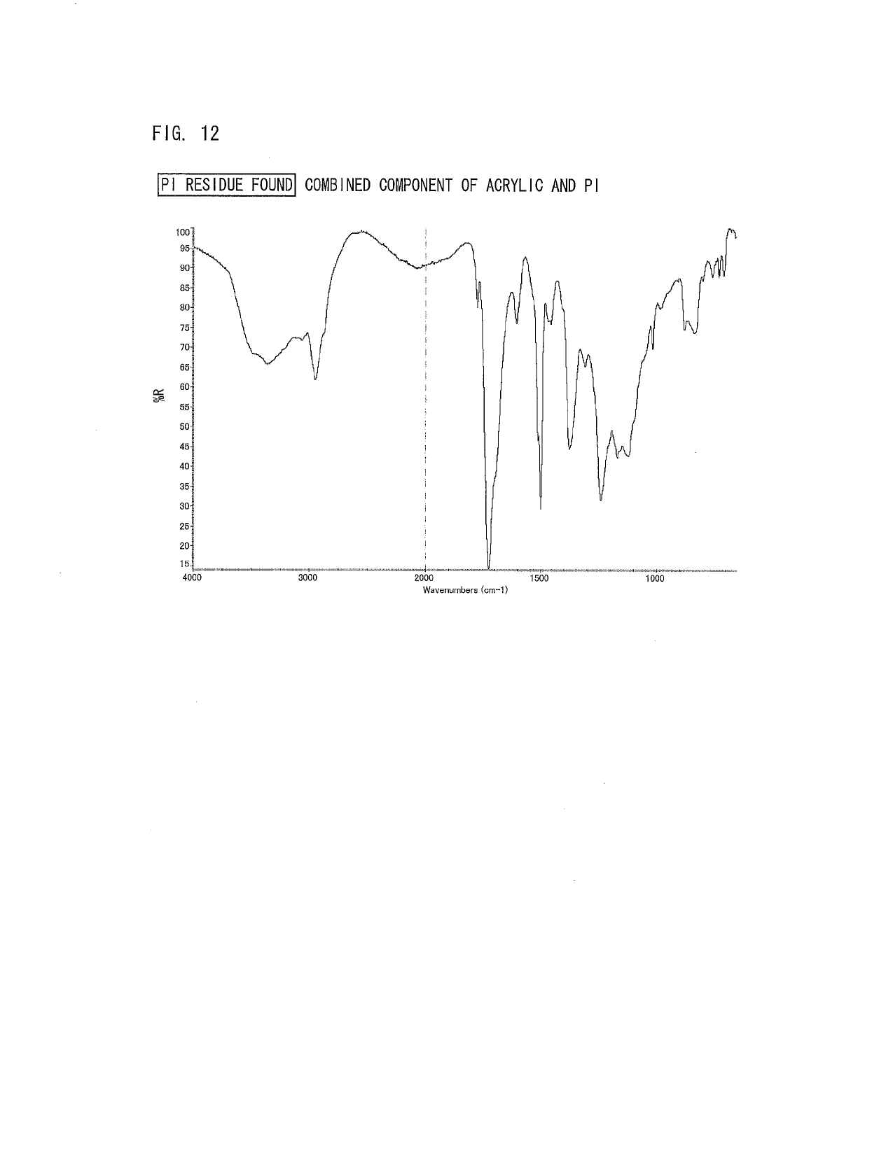

FIG. 12 is a diagram showing a spectrum that is displayed on a display section in a case where there is a PI residue found.

In a case where there is a PI residue found, a spectrum containing a combined component of acrylic and PI (see FIG. 12) is displayed.

Meanwhile, in a case where no residue of the alignment film 21 is present on the apical surface 51a of any switch PS electrode 51, as in the case of the counter substrate 11 shown in (b) of FIG. 11 (i.e., the counter substrate 11 is non-defective), infrared light emitted from the light source 102 is (i) transmitted through the transparent electrode 27 (ITO) and the switch PS 58 (acrylic) in this order, (ii) reflected by the reflection coating 38, (iii) transmitted through the switch PS 58 and the transparent electrode 27 in this order, and (iv) received by the detector 103. This causes the display section 120 to display a spectrum on which only an acrylic component appears.

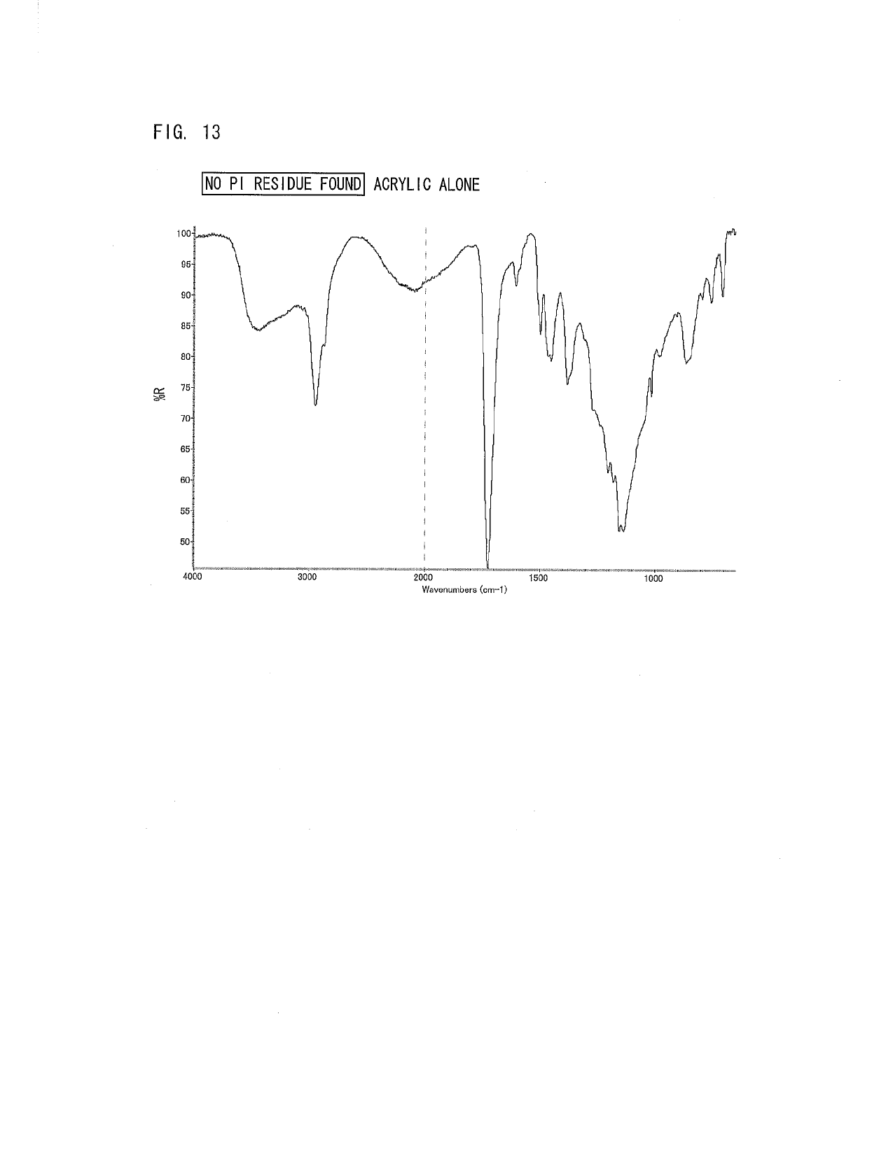

FIG. 13 is a diagram showing a spectrum that is displayed on the display section in a case where there is no PI residue found.

In a case where there is no PI residue found, a spectrum on which only a component indicative of acrylic appears is displayed on the display section 120 (see FIG. 13).

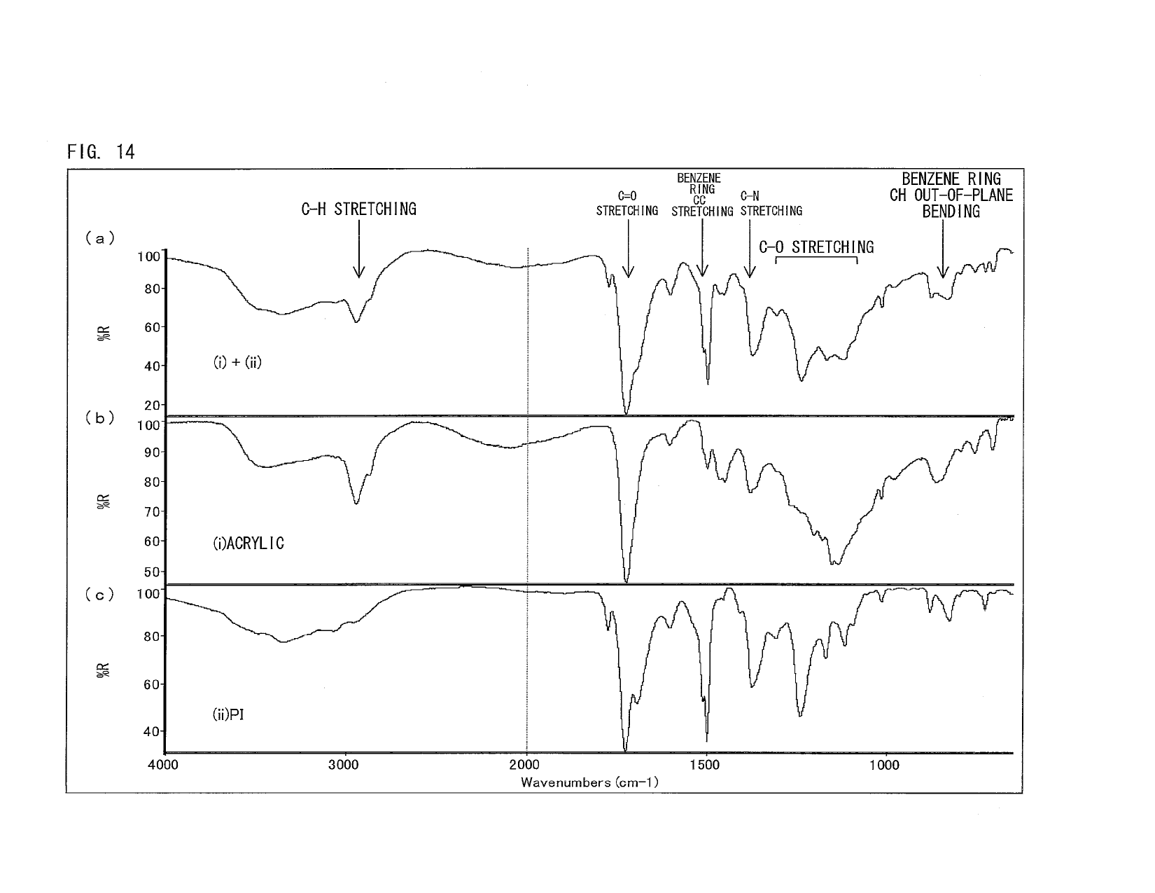

(a) through (c) of FIG. 14 are diagrams explaining positions of molecular vibrations by infrared absorption.

(a) of FIG. 14 shows a spectrum containing a combined value of an acrylic resin and PI. (b) of FIG. 14 shows a spectrum on which only a component indicative of acrylic appears. (c) of FIG. 14 shows a spectrum on which only a component indicative of PI appears.

In a case where infrared light is absorbed by molecular vibrations, an absorption peak appears in a specific wave number range of reflected light that is received by the detector 103. By confirming (i) at which wave number the absorption peak appears and (ii) what shape the absorption peak has, a substance through which the infrared light has been transmitted can be specified.

A method for determining the presence or absence of a PI residue from a spectrum that is displayed on the display section 120 is described with reference to FIG. 14.

As shown in (a) of FIG. 14, a spectrum indicative of (i) acrylic+(ii) PI reveals that infrared absorption causes molecular vibrations to occur due to C—H stretching near a wave number of 2900 to 2800 cm⁻¹, C═O stretching near a wave number of 1700 cm⁻¹, benzene ring CC stretching near a wave number of 1500 cm⁻¹, C—N stretching near a wave number of 1380 cm⁻¹, C—O stretching near a wave number of 1200 to 1300 cm⁻¹, and benzene ring CH out-of-plane bending near a wave number of 800 cm⁻¹.

Meanwhile, as shown in (b) of FIG. 14, (i) acrylic reveals that infrared absorption causes molecular vibrations to occur due to C—H stretching near a wave number of 2900 to 2800 cm⁻¹, C═O stretching near a wave number of 1700 cm⁻¹, benzene ring CC stretching near a wave number of 1500 cm⁻¹, C—O stretching near a wave number of 1200 to 1300 cm⁻¹, and benzene ring CH out-of-plane bending near a wave number of 800 cm⁻¹.

Further, as shown in (c) of FIG. 14, (ii) PI reveals that infrared absorption causes molecular vibrations to occur due to C═O stretching near a wave number of 1700 cm⁻¹, benzene ring CC stretching near a wave number of 1500 cm⁻¹, C—N stretching near a wave number of 1380 cm⁻¹, and C—O stretching near a wave number of 1200 to 1300 cm⁻¹.

It is revealed that the spectrum shown in (a) of FIG. 14 is a combined component of the spectrum shown in (b) of FIG. 14 and the spectrum shown in (c) of FIG. 14.

This allows an inspector to determine the presence or absence of a PI residue by checking whether or not these molecular vibrations due to C—H stretching, C═O stretching, benzene ring CC stretching, C—N stretching, C—O stretching, and benzene ring CH out-of-plane bending have occurred, i.e., whether or not infrared absorption due to molecular vibrations has occurred.

As described above, it is possible to allow an inspector to easily determine the presence or absence of s residue PI 21′ by using the FT-IR reflection method to measure the intensity of light reflected by the reflection coatings 38 at each wave number.

Therefore, unlike in the case of use of an optical microscope, it is not necessary to resort to an inspector's visual observation to determine the presence or absence of a residue on the apical surface 51a of any switch PS electrode 51. This makes it possible to reasonably and accurately to determine the presence or absence of a residue on the apical surface 51a of any switch PS electrode 51.

The presence or absence of a residue may be determined by measuring the apical surface 51a of each of the switch PS electrodes 51 provided in the counter substrate 11 or by randomly measuring several areas on a substrate included in a production lot in which a defect may occur.

Once it is determined that a counter substrate 11 has no PI residue on the apical surface 51a of any switch PS electrode 51 and that an active substrate 12 measured has no PI residue on the surface 52a of any switch electrode 52, the counter substrate 11 and the active substrate 12 proceed as non-defective products to a next step in which the counter substrate 11 and the active substrate 12 are bonded to each other.

However, once it is determined that a counter substrate 11 has a PI residue on the apical surface 51a of a switch PS electrode 51 and that an active substrate 12 measured has a PI residue on the surface 52a of a switch electrode 52, the counter substrate 11 and the active substrate 12 proceed as defective products to the aforementioned PI removing step, in which the PI residues are removed. After that, the counter substrate 11 and the active substrate 12 are bonded to each other.

Next, the switch electrode inspecting step (switching electrode inspecting step) of inspecting the switch electrodes 52 of an active substrate 12 is described.

The switch electrode inspecting step can also be executed by the aforementioned switching electrode inspection apparatus 100.

The switch electrodes 52 of an active substrate 12 contain no acrylic material, and the switch electrodes 52 made of ITO are stacked directly on the reflection coatings 39.

Therefore, the switch electrode inspecting step is identical to the switch PS electrode inspecting step except that a spectrum containing no component indicative of acrylic is obtained from light reflected by the reflection coating 39.

When an active substrate 12 comes, the light source 102 emits infrared light onto the surfaces 52a of the switch electrodes 52 of the active substrate 12, i.e., onto the alignment-film-32-free regions (infrared light emitting step).

Next, the detector 103 receives (obtains) reflected light from the reflection coatings 39 reflecting the infrared light emitted from the light source 102, when the active substrate 12 is seen in plan view, each of the reflection coatings 39 appearing to be overlapping a corresponding one(s) of the switch electrodes 52, which are in the alignment-film-32-free regions (reflected light obtaining step).

Further, the detector 103 converts the received reflected light into a spectrum (conversion-into-spectrum step).

Next, the data conversion section 112 (i) performs digital conversion on the spectrum outputted from the detector 103 and (ii) sets a vertical axis and a horizontal axis so as to cause the display section 120 to display the spectrum (conversion-into-spectrum step). Then, the data conversion section 112 outputs, to the display section 120, the spectrum on which the digital conversion has been performed and in which the vertical and horizontal axes have been set, and then the display section 120 displays the spectrum.

In this way, the display section 120 displays the spectrum of the reflected light received (obtained) by the detector 103 (displaying step).

In a case where a PI residue is present on the surface 52a of any switch electrode 52 the counter substrate 12 is defective), the detector 103 outputs, to the data conversion section 112, a spectrum indicative of a PI component as a spectrum of the light reflected by the reflection coatings 39.

Then, the data conversion section 112 causes the display section 120 to display the spectrum indicative of a PI component, as in the case of the spectrum shown in (c) of FIG. 14. Thus, in a case where the display section 120 displays the spectrum indicative of a PI component, an inspector can determine that a PI residue is present on the surface 52a of any switch electrode 52. It should be noted that the subsequent steps to be executed on the active substrate 12 are identical to those executed on the counter substrate 11.

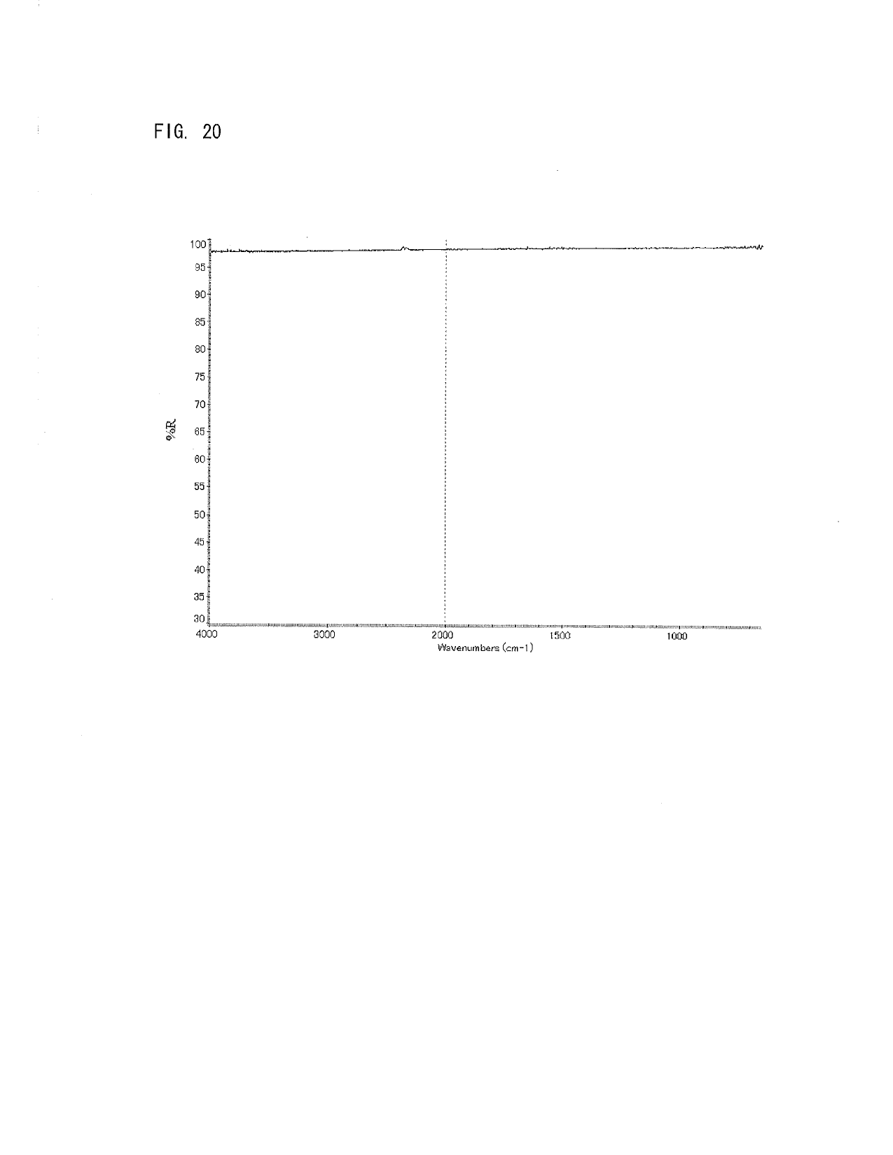

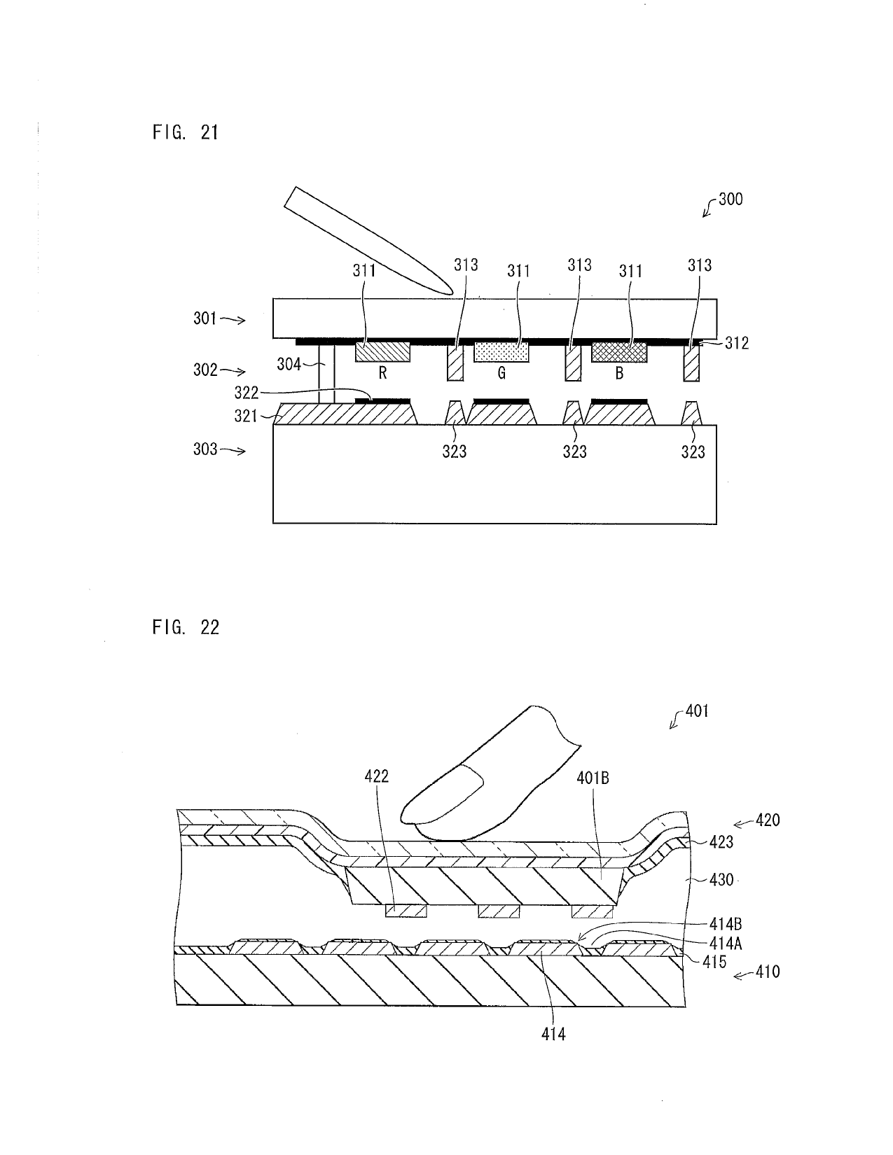

Meanwhile, in a case where no PI residue is present on the surface 52a of any switch electrode 52 (i.e., the counter substrate 12 is non-defective), the detector 103 outputs, to the data conversion section 112, a spectrum containing no such component as acrylic or PI, as in the case of the spectrum shown in FIG. 20, as a spectrum of the light reflected by the reflection coatings 39.

FIG. 20 is a diagram showing a spectrum indicating that no PI residue is present on a surface of a switch electrode. In the case a non-defective switch electrode 52, which has no organic matter thereon, a linear spectrum having no peak of infrared absorption is obtained (see FIG. 20).

Then, the data conversion section 112 causes the display section 120 to display a spectrum containing no such component as acrylic or PI and indicating that the light has been transmitted through ITO alone. By the display section 120 thus displaying the spectrum indicating that the light has been transmitted through ITO alone, an inspector can be made to determine that no PI residue is present on the surface 52a of any switch electrode 52. It should be noted that the subsequent steps to be executed on the active substrate 12 are identical to those executed on the counter substrate 11.

As described above, a method for inspecting the counter substrate 11 (active substrate 12) includes: an infrared light emitting step of emitting infrared light onto a plurality of switch PS electrodes 51 or plural sets of switch PS electrodes 51 each of which forms a switch with a corresponding one of the plurality of electrodes 52 (switch PS electrodes 51) or with a corresponding one of the plural sets of electrodes 52 (switch PS electrodes 51) of the active substrate 12 (counter substrate 11), and each of which makes electrical conduction with the corresponding one of the plurality of electrodes 52 or with the corresponding one of the plural sets of electrodes 52 of the active substrate 12) when either the counter substrate 11 or the active substrate 12 is pressed against the other with the counter substrate 11 (active substrate 12) placed opposite the active substrate 12 (counter substrate 11); a reflected light obtaining step of obtaining reflected light from reflection coatings 38 (reflection coatings 39) reflecting the infrared light emitted in the infrared light emitting step; and a spectrum displaying step of displaying a spectrum of the reflected light obtained in the reflected light obtaining step.

According to this arrangement, infrared light is emitted onto the plurality of switch PS electrodes 51 (switch electrodes 52) or the plural sets of switch PS electrodes 51 (switch electrodes 52) in the infrared light emitting step, and reflected light from the reflection coatings 38 (reflection coatings 39) reflecting the infrared light emitted in the infrared light emitting step is obtained in the reflected light obtaining step. Then, a spectrum of the reflected light from the reflection coatings 38 (alignment film 39) is displayed on the display section 120 in the spectrum displaying step.

For example, having an inspector view the spectrum displayed on the display section 120, makes it possible for the inspector check the presence or absence, on the apical surface 51a of any switch PS electrode 51, of a residue of the alignment film 21, the residue that causes faulty electrical conduction with the corresponding one of the plurality of switch electrodes 52 or with the corresponding one of the plural sets of switch electrodes 52 of the active substrate 12 (counter substrate 11).

Thus, the foregoing arrangement makes it possible to fabricate the active substrate 12 (counter substrate 11) while efficiently and surely checking the presence or absence of an element that causes a failure to occur in any touch switch 50.

It should be noted that the foregoing description assumes that the reflected light obtained from the reflection coatings 38 in the reflected light obtaining step is converted into a spectrum and then the spectrum of the reflected light is displayed in the displaying step. However, the present invention is not limited to this, but may be arranged as follows: It is possible to, instead of displaying the spectrum of the reflected light in the displaying step, use the control section 110 or the like to analyze whether the reflected light obtained from the reflection coatings 38 in the reflected light obtaining step contains a PI residue and then, in the displaying step, displaying only a result of the analysis as to the presence or absence of a PI residue or a result of determination as to whether the counter substrate 11 or the active substrate 12 is non-defective or defective.

The method further includes a determining step of determining, from the spectrum of the reflected light obtained in the reflected light obtaining step, whether the alignment film 21 (alignment film 32) is present or absent on the apical surface 51a of any switch PS electrode 51 (the surface 52a of any switch electrode 52).

According to the foregoing arrangement, the determining step makes it possible to determine the presence or absence of the alignment film 21 (alignment film 32) on the apical surface 51a of any switch PS electrode 51 (the surface 52a of any switch electrode 52). This prevents a misjudgment from being made by an inspector, thus making it possible to fabricate a liquid crystal display panel substrate while efficiently and surely checking the presence or absence of an element that causes a failure to occur in any of those switches.

Such a method for inspecting the counter substrate 11 (active substrate 12) as that described above includes an infrared light emitting step of emitting infrared light onto a plurality of switch PS electrodes 51 (switch electrodes 52) or plural sets of switch PS electrodes 51 (switch PS electrodes 52) each of which (i) forms a switch with a corresponding one of the plurality of electrodes 52 (switch PS electrodes 51) or with a corresponding one of the plural sets of electrodes (switch PS electrodes 51) of the active substrate 12 (counter substrate 11) and each of which makes electrical conduction with the corresponding one of the plurality of electrodes 52 (switch PS electrodes 51) or with the corresponding one of the plural sets of electrodes 52 (switch PS electrodes 51) of the active substrate 12 (counter substrate 11) when either the counter substrate 11 or the active substrate 12 is pressed against the other with the counter substrate 11 (active substrate 12) placed opposite the active substrate 12 (counter substrate 11).

The method further includes: a reflected light obtaining step of obtaining reflected light from reflection coatings 38 (reflection coatings 39) reflecting the infrared light emitted in the infrared light emitting step; and a spectrum displaying step of displaying a spectrum of the reflected light obtained in the reflected light obtaining step.

Thus, infrared light is emitted onto the plurality of switch PS electrodes 51 (switch electrodes 52) or the plural sets of switch PS electrodes 51 (switch electrodes 52) in the infrared light emitting step, and reflected light from the reflection coatings 38 (reflection coatings 39) which reflect the infrared light emitted in the infrared light emitting step and on which the plurality of switch PS electrodes 51 (switch electrodes 52) or the plural sets of switch PS electrodes 51 (switch electrodes 52) are stacked is obtained in the reflected light obtaining step. Then, a spectrum of the reflected light from the reflection coatings 38 (reflection coatings 39) is displayed in the spectrum displaying step.

According to this arrangement, for example, having an inspector view the spectrum displayed in the displaying step makes it possible for the inspector to check the presence or absence, on the apical surface 51a of any switch PS electrode 51 (on the surface 52a of any switch electrode 52), of a residue of the alignment film 21 (residue of the alignment film 32) that causes faulty electrical conduction with the corresponding one of the plurality of switch electrodes 52 (switch PS electrodes 51) or with the corresponding one of the plural sets of switch electrodes 52 (switch PS electrodes 51) of the active substrate 12 (counter substrate 11). This makes it possible to efficiently and surely check the presence or absence of an element that causes a failure to occur in any of those switches.

In the conversion-into-spectrum step, the data conversion section 112 converts infrared light whose wave number falls within a mid-infrared range of 4000 cm⁻¹ to 650 cm⁻¹ into a spectrum, and then outputs, to the display section 120, the spectrum obtained by the conversion.

This makes it possible to, while reducing the volume of data to be obtained, obtain data on a spectrum necessary for checking the presence or absence, on the apical surface 51a of any switch PS electrode 51 (the surface 52a of any switch electrode 52), the alignment film 21 (alignment film 32) that causes faulty electrical conduction with the corresponding one of the plurality of switch PS electrodes 51 (switch electrodes 52) or with the corresponding one of the plural sets of switch PS electrodes 51 (switch electrodes 52) of the active substrate 12 (counter substrate 11).

The method further includes the step of checking the spectrum obtained in the conversion-into-spectrum step for any molecular vibrations due to C—H stretching, C═O stretching, benzene ring CC stretching, C—N stretching, C—O stretching, and benzene ring CH out-of-plane bending. This makes it possible to determine whether or not the reflected light contains any component indicative of acrylic and polyimide.

That is, in order to allow an inspector to check the spectrum obtained in the conversion-into-spectrum step for any molecular vibrations due to C—H stretching, C═O stretching, benzene ring CC stretching, C—N stretching, C—O stretching, and benzene ring CH out-of-plane bending, the method includes the step of displaying the spectrum on the display section 120.

Therefore, in a case where an inspector checks the display section 120 on which the spectrum is displayed, the inspector can determine whether or not the spectrum indicates the presence of any molecular vibrations due to C—H stretching, C═O stretching, benzene ring CC stretching, C—N stretching, C—O stretching, and benzene ring CH out-of-plane bending. Thus, the inspector can determine whether or not the reflected light contains any component indicative of acrylic and polyimide.

This makes it possible for an inspector, in a case where each of the switch PS electrodes 51 each stacked on a corresponding one of the reflection coatings 38 is constituted by a switch PS 58 made of an acrylic material and a transparent electrode 27 made of ITO, to determine whether or not polyimide, which is generally used as the alignment film 21, is stacked on that switch PS electrode 51. This makes it possible to efficiently and surely check the presence or absence of a residue of the alignment film 21, the residue causing a failure to occur in any of the touch switches 50.

Thus, in a case where the presence or absence of a PI residue is measured by the FT-IR reflection method after formation of the reflection coatings 38 and 39, it is possible to determine the presence or absence of a PI residue with great ease and in a short time. This can prevent variations in judgment due to differences among inspectors.

The counter substrate 11 has the reflection coatings 38 disposed below each separate one of the plurality of switch PS electrodes 51 or below each separate one of the plural sets of switch PS electrodes 51, while the active substrate 12 has the reflection coatings 39 disposed below each separate one of the plurality of switch PS electrodes 52 or below each separate one of the plural sets of switch PS electrodes 52. This makes it possible to measure the switch PS electrodes 51 and the switch PS electrodes 52 with use of the FT-IR reflection method. Therefore, since it is possible to measure the presence or absence of a PI residue without destroying the counter substrate 11 and the active substrate 12, the switch PS electrode inspecting step and the switch electrode inspecting step can be introduced into the fabrication process.

Thus, in a case where the switch PS electrode inspecting step and the switch electrode inspecting step are introduced into the fabrication process, it is also possible to immediately respond to the occurrence of an unexpected trouble during the process for forming the switch PS electrodes 51 or during the process for forming the switch electrodes 52, thereby making it possible (i) to give an immediate feed back to the process for forming the switch PS electrodes 51 or to the process for forming the switch electrodes 52 and (ii) to resolve the trouble.

This enhances production efficiency, thereby allowing an increase in yield. Further, since it is comparatively easy to carry out the measurement with use of the FT-IR reflection method, not only costs for the measurement but also labor costs can be reduced.

This makes it possible to reduce the total cost of production.

While there are various methods considered for determining the presence or absence of a PI residue on a surface of a switch constituting a touch switch, using the switching electrode inspection apparatus 100 (switching electrode inspection method) as described above after having prepared a trial product for examination from which a PI has been removed makes it possible to easily check whether the PI residue has been really removed, thus making it possible to contribute to a reduction in the amount of time for technical examination.

As described above, the counter substrate 11 constituting the liquid crystal display panel 1 is provided with the reflection coatings 38, and the active substrate 12 is provided with the reflection coatings 39.

The reflection coatings 38 and 39 are components that are provided for checking the presence or absence of a PI residue on the counter substrate 11 or on the active substrate 12. That is, it is not so desirable that the existence of the reflection coatings 38 and 39, which are provided for checking the quality of the counter substrate 11 and the active substrate 12, respectively, be known to a general user.

However, it is difficult for a general user to recognize the existence of the reflection coatings 38 and 39 unless the general user dissembles the liquid crystal display panel 1 (module) and detects a cross section with an optical microscope or SEM. Even if the general user recognizes the existence of the reflection coatings 38 and 39, it is difficult for the general user even to guess the meaning of the existence of the reflection coatings 38 and 39.

As described above, use of the method for checking the presence or absence of a PI residue by using the switching electrode inspection apparatus 100 (switching element inspection method) makes it possible to provide the counter substrate 11 and the active substrate 12 with the reflection coatings 38 and 39, which are difficult for a user to recognize and the meaning of whose existence is difficult to guess. Further, it is possible to provide the counter substrate 11 and the active substrate 12 with the reflection coatings 38 and 39 without losing the appearance quality of the liquid crystal display panel 1.

### Embodiment 2

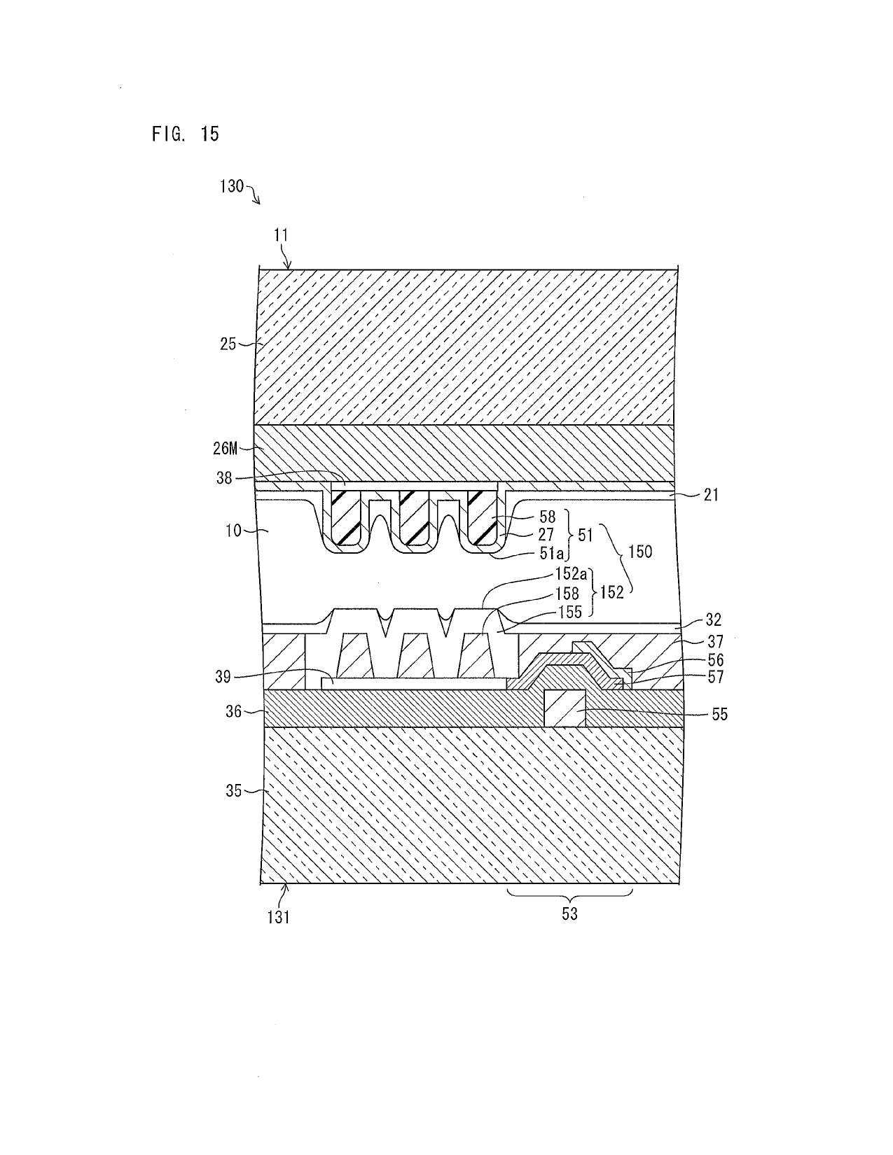

Next, a second embodiment of the present invention is described with reference to FIG. 15. For convenience of explanation, members having functions identical to those of the respective members described in Embodiment 1 are given respective identical reference numerals, and a description of those members is omitted here.

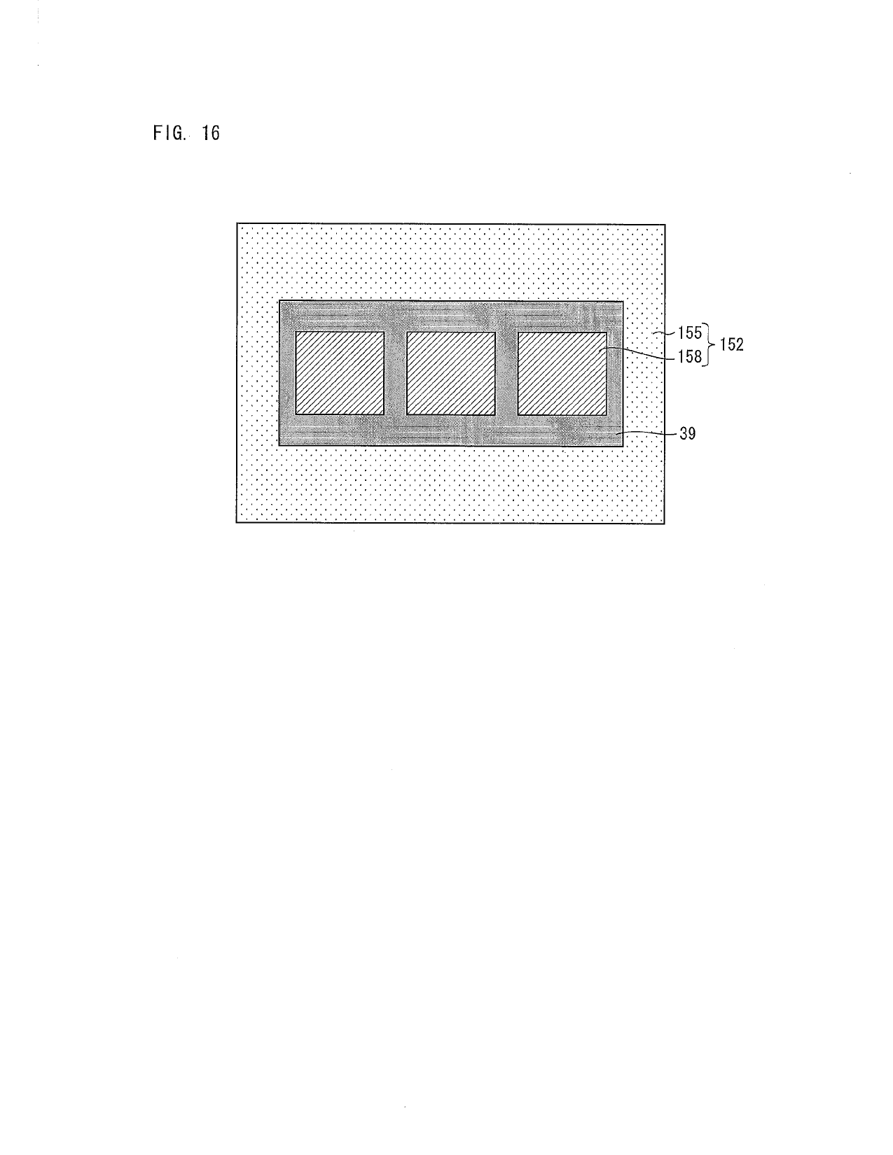

FIG. 15 is a cross-sectional view showing a configuration of a touch switch provided in a liquid crystal display panel according to a second embodiment of the present invention. FIG. 16 is a plan view showing a configuration of a switch electrode of an active substrate according to the second embodiment.

Touch switches (switches) 150 according to the second embodiment differ from the touch switches (switches) 50 described in Embodiment 1 in that each of the switching electrodes provided on the active matrix substrate 12 side is in the shape of a protrusion.

A liquid crystal display panel 130 includes touch switches 150 instead of the touch switches 50 of the liquid crystal display panel 1.

Each of the touch switches 150 includes switch PS electrodes 51 of a counter substrate 11 and switch electrodes (electrodes of the other substrate, sets of electrodes of the other substrate, switching electrodes, sets of switching electrodes, first switching electrodes) 152 of an active substrate (other substrate, liquid crystal display panel substrate) 131.

The switch PS electrodes 51 of the counter substrate 11 are identical in configuration to those of Embodiment 1.

The active substrate 131 includes the switch electrodes (electrodes of the other substrate, switching electrodes, first switching electrodes) 152 instead of the switch electrodes 52 of the active substrate 12. Each of the switch electrodes 152 is constituted by a columnar protrusion (structure) 158 and a transparent electrode 155.

The switch electrodes 152 are in the same positions as the switch electrodes 52 (see FIG. 3) described in Embodiment 1. That is, each of the switch electrodes 152 also serves as a drain electrode for a position detector TFT 53 of the corresponding touch switch 150. The switch electrodes 152 are obtained by providing columnar protrusions 158 between the switch electrodes 52 described in Embodiment 1 and the respective reflection coatings 39.

As shown in FIG. 16, when the switch electrodes 152 are seen in plan view, each of the reflection coatings 39 appears to be provided in a region where the corresponding switch electrodes 152 are provided. The reflection coatings 39 are island-dotted as in the case of those of Embodiment 1.

The columnar protrusions 158 are provided on the surface of the reflection coating 39. As shown in FIG. 16, when the active substrate 131 is seen in plan view, the columnar protrusions 158 are provided in a region where the reflection coating 39 is provided. In the second embodiment, the active substrate 131 has a set of three columnar protrusions 158 provided for each separate reflection coating 38.

The columnar protrusions 158 are formed by the same process as that used in forming an interlayer insulating film 37. That is, the columnar protrusions 158 are made of the same resin material as that of which the interlayer insulating film 37 is made.

As shown in FIG. 15, the transparent electrodes 155, made of ITO, are provided so as to cover the columnar protrusions 158. The transparent electrodes 155 are formed by the same process as that used in forming the pixel electrodes 15, whereby switch electrodes 152 are formed. Each of the transparent electrodes 155 constituting the switch electrodes 152 covers part of a semiconductor layer 57.

Moreover, the alignment film 32 is formed, except for those apical surfaces 152a of the switch electrodes 152 which face the apical surfaces 51a of the switch PS electrodes 51 of the counter electrode 11, respectively.

Since each of the switch electrodes 152 is in the shape of a protrusion, such a shape is not completely surpassed by a polyimide solution of which the alignment film 32 is made, and thus the polyimide solution forms a film. This causes the apical surfaces 152a of the switch electrodes 152 to be alignment-film-32-free regions on which the alignment film 32 is selectively not provided.

Further, in order to surely remove a PI residue from the apical surface 152a of a switch electrode 152, it is also possible, for example, to subject the apical surface 152a of the switch electrode 152 to an ashing process in the aforementioned PI removing step.

Further, as described with reference to FIG. 9, each of the switch electrode 152 may have its apical surface in the shape of a convex surface. This shape makes it easier to shed PI.

The liquid crystal display panel 130 is completed by bonding the active substrate 131 thus formed and the counter substrate 11 to each other with a liquid crystal layer sandwiched therebetween.

Thus, the liquid crystal display panel 130 is configured such that both the switch PS electrodes 51 and the switch electrodes 152 of the touch switches 150 have protruding shapes. This configuration makes it possible to more surely make electrical conduction between each of the switch PS electrodes 51 and a corresponding one of the switch electrodes 152 when either the counter substrate 11 or the active substrate 131 is pressed against the other, thus making it possible to prevent faulty electrical conduction or the like from occurring.

It should be noted that the number of switch electrodes 152 in each set to be provided on each reflection coating 39 is not limited to three. Alternatively, plural (two, or four or more) switch electrodes 152 or a single switch electrode 152 may be provided on each reflection coating 39.

Further, the transparent electrodes 155 constituting the switch electrodes 152 may be configured to be connected to the semiconductor layer 57 for the position detector TFT 53 via a contact hole formed in the interlayer insulating film 37.

Further, each of the transparent electrodes 155 may have its thickness appropriately set as needed. The transparent electrodes 155 substantially as thick as the interlayer insulating film 37 as shown in FIG. 15, or may be thinner than the interlayer insulating film 37.

### Embodiment 3

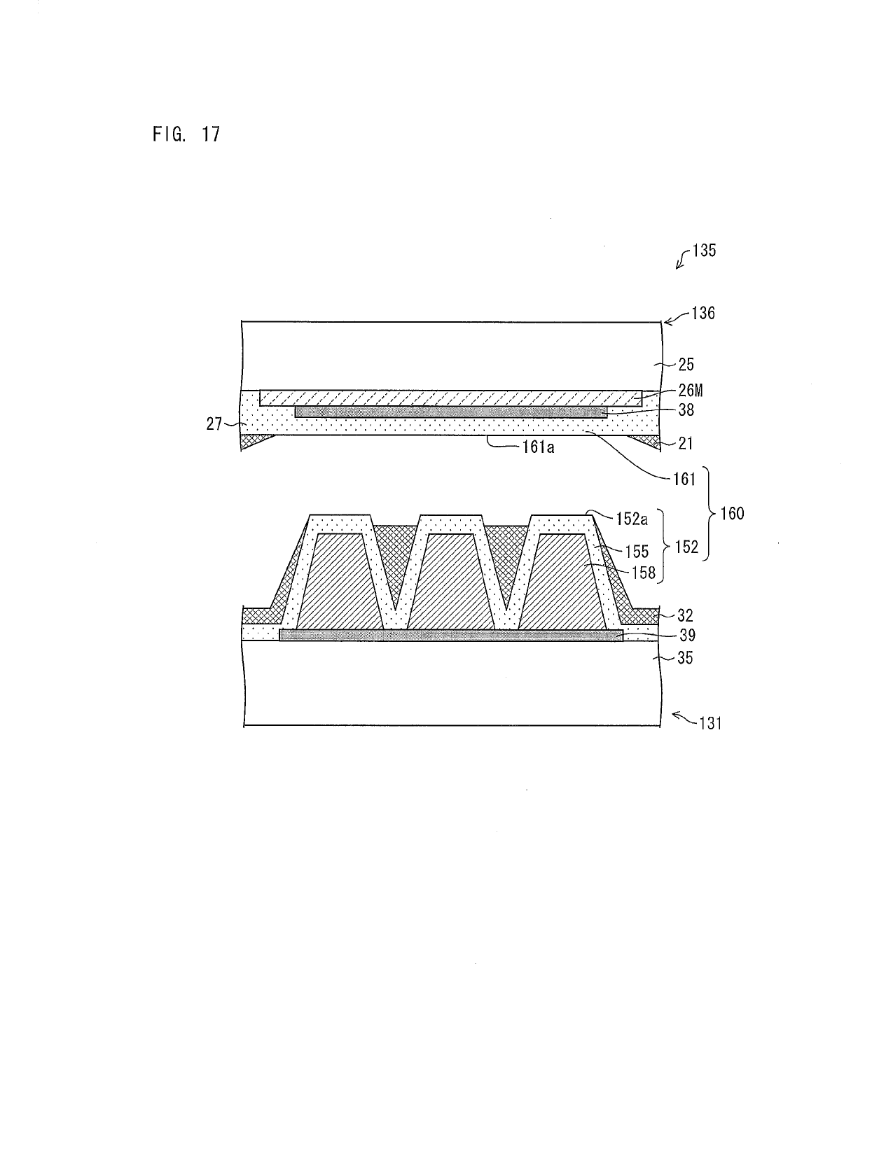

Next, a third embodiment of the present invention is described with reference to FIG. 17. For convenience of explanation, members having functions identical to those of the respective members described in Embodiments 1 and 2 are given respective identical reference numerals, and a description of those members is omitted here.

FIG. 17 is a cross-sectional view showing a configuration of a touch switch provided in a liquid crystal display panel according to the third embodiment.

Touch switches (switches) 160 according to the third embodiment differ from the touch switches (switches) 150 described in Embodiment 2 in that each of switching electrodes provided on the counter substrate 11 side is flat instead of being in the shape of a protrusion.

A liquid crystal display panel 135 includes touch switches 160 instead of the touch switches 150 of the liquid crystal display panel 130.

Each of the touch switches 160 includes a switching electrode (electrode of the other substrate, second switching electrode) 161 of a counter substrate (a liquid crystal display panel substrate, the other substrate) 136 and switch electrodes (electrodes of the other substrate, switching electrodes, first switching electrodes) 152 of an active substrate 131.

The active substrate 131 is identical to that described in Embodiment 2. Note that FIG. 17 omits to illustrate the gate insulating film 36 provided between the glass substrate 35 and the reflection coatings 39.

The counter substrate 136 is configured such that no columnar protrusion or the like is formed on the back surface of any reflection coating 38 (i.e., on that surface of the reflection coating 38 which faces away from the light-shielding layer 26M) and the back surface of each reflection coating 38 is covered with the transparent electrode 27.

The transparent electrode 27, which covers the back surface of each reflection coating 38, serves as the switching electrode 161.

The front surface 161a of the switching electrode 161 (that surface of the switching electrode 161 which faces the switch electrodes 152) is an alignment-film-21-free region on which the alignment film 32 is selectively not provided. That is, the front surface 161a of the switching electrode 161 is exposed, i.e., is not covered with the alignment film 21.

In an alignment film forming step, a polyimide film is formed on the transparent electrode 27 by applying a polyimide solution to the transparent electrode 27 and then baking the polyimide solution thus applied. Thereafter, the polyimide film on the switching electrode 161 is selectively removed by carrying out an ashing process in a PI removing step. This causes the surface 161a of the switching electrode 161 to be the alignment-film-21-free region on which the alignment film 32 is selectively not provided.

The liquid crystal display panel 130 is completed by bonding the counter substrate 136 thus formed and the active substrate 131 with a liquid crystal layer sandwiched therebetween.

Thus, the liquid crystal display panel 135 is configured such that the switch electrodes 152 of the touch switches 160 each constituted by the switching electrode 161 and the switch electrodes 152 have protruding shapes. This configuration makes it possible to surely make electrical conduction between the switching electrode 161 and the switch electrodes 152 when either the active substrate 131 or the counter substrate 136 is pressed against the other, thus making it possible to prevent faulty electrical conduction or the like from occurring.

### Embodiment 4

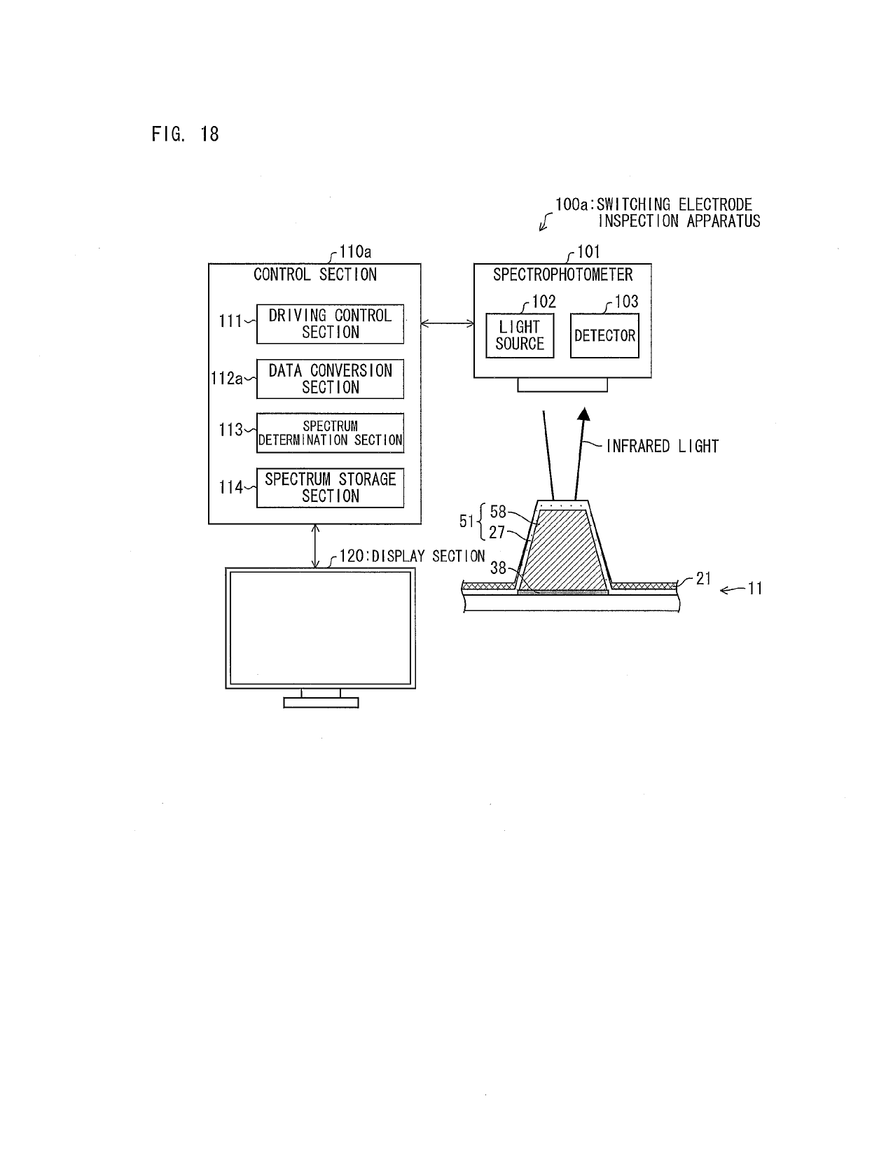

Next, a fourth embodiment of the present invention is described with reference to FIG. 18. For convenience of explanation, members having functions identical to those of the respective members described in Embodiments 1 through 3 are given respective identical reference numerals, and a description of those members is omitted here.

FIG. 18 is a diagram showing a configuration of a switching electrode inspection apparatus 100a according to the fourth embodiment.

The switching electrode inspection apparatus 100a differs from the switching electrode inspection apparatus 100 in that the switching electrode inspection apparatus 100a includes a control section 110a.

The control section 110a differs from the control section 110 in that the control section 110a includes a data conversion section 112a instead of the data conversion section 112 and further includes a spectrum determination section 113 and a spectrum storage section 114.

The data conversion section 112a (i) performs digital conversion on a spectrum supplied from a detector 103 and (ii) sets a vertical axis and a horizontal axis so as to cause the display section 120 to display the spectrum. Subsequently, the data conversion section 112a outputs, to the spectrum determination section 113, the spectrum on which the digital conversion has been performed and in which the vertical and horizontal axes have been set.

The spectrum determination section 113 determines whether or not there is a PI residue found on the surface of any alignment-film-21-free region.

Upon obtaining the spectrum from the data conversion section 112a, the spectrum determination section 113 performs a search algorithm process on the obtained spectrum by application of a search formula, thereby calculating (a) a degree of similarity between the obtained spectrum and a spectrum which is stored in the spectrum storage section 114 in advance and indicates that there is a PI residue found and (b) a degree of similarity between the obtained spectrum and a spectrum which is stored in the spectrum storage section 114 in advance and indicates that there is no PI residue found. It should be noted that the search formula used may be a publicly-known formula.

The spectrum determination section 113 determines the presence or absence of a residue of the alignment film 21 on the apical surface 51a of any switch PS electrode 51 or a residue of the alignment film 32 on the surface 52a of any switch electrode 52 by performing the search algorithm process on the obtained spectrum and then determining a magnitude relationship between (a) the degree of similarity between the obtained spectrum and the spectrum which indicates that there is a PI residue found and (b) the degree of similarity between the obtained spectrum and the spectrum which indicates that there is no PI residue found (determining step).

The spectrum determination section 113 outputs, to the display section 120, (a) the calculated degree of similarity between the obtained spectrum and the spectrum which indicates that there is a PI residue found and (b) the calculated degree of similarity between the obtained spectrum and the spectrum which indicates that there is no PI residue found.

The magnitude relationship between (a) the degree of similarity between the obtained spectrum and the spectrum which indicates that there is a PI residue found and (b) the degree of similarity between the obtained spectrum and the spectrum which indicates that there is no PI residue found allows an inspector to check whether or not there is a PI residue found on the surface of any alignment-film-21-free region.

That is, the spectrum determination section 113 outputs, to the display section 120 as results of determination of whether or not there is a PI residue found on the surface of any alignment-film-21-free region or the surface of any alignment-film-32-free region, (a) the degree of similarity between the obtained spectrum and the spectrum which indicates that there is a PI residue found and (b) the degree of similarity between the obtained spectrum and the spectrum which indicates that there is no PI residue found.

Further, the spectrum determination section 113 outputs, to the display section 120, not only the foregoing results of determination but also the spectrum obtained from the data conversion section 112a, the spectrum which is stored in the spectrum storage section 114 in advance and indicates that there is a PI residue found, and the spectrum which is stored in the spectrum storage section 114 in advance and indicates that there is no PI residue found.

The display section 120 displays (i) the foregoing results of determination which has been obtained from the spectrum determination section 113 and is (a) the degree of similarity between the obtained spectrum and the spectrum which indicates that there is a PI residue found and (b) the degree of similarity between the obtained spectrum and the spectrum which indicates that there is no PI residue found, (ii) the spectrum (measured spectrum) obtained from the data conversion section 112a, (iii) the spectrum which indicates that there is a PI residue found, and (iv) the spectrum which indicates that there is no PI residue found.

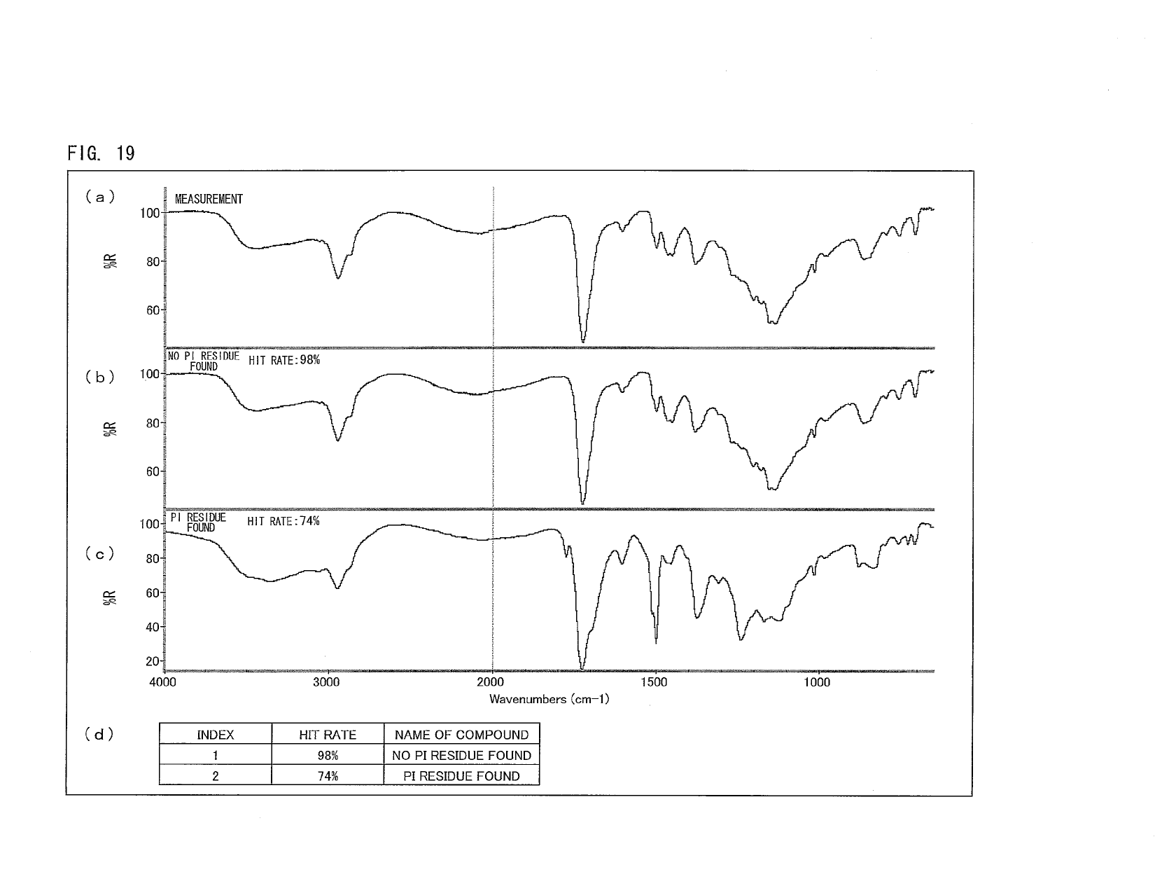

FIG. 19 is a diagram showing results of determination of the presence or absence of PI residues, as displayed on the display section 120. It should be noted that FIG. 19 shows results of determination of the presence or absence of PI residues on the apical surface 51a of any switch PS electrode 51.

(a) of FIG. 19 shows a measured spectrum, (b) of FIG. 19 shows a spectrum which indicates that there is no PI residue found, and (c) of FIG. 19 shows a spectrum which indicates that there is a PI residue found. It should be noted that a “hit ratio” in the spectrum of (b) of FIG. 19 indicates a degree of similarity between the measured spectrum and the spectrum which indicates that there is no PI residue found, and a “hit ratio” in the spectrum of (c) of FIG. 19 indicates a degree of similarity between the measured spectrum and the spectrum which indicates that there is a PI residue found.

It should also be noted that (d) of FIG. 19 tabulates the results of determination which are shown in (b) and (c) of FIG. 19.

As shown in (b) and (d) of FIG. 19, the “hit ratio” between the measured spectrum and the spectrum which indicates that there is no PI residue found is 98%. As shown in (c) and (d) of FIG. 19, the “hit ratio” between the measured spectrum and the spectrum which indicates that there is a PI residue found is 74%.

These results allow an inspector to determine that the measured spectrum contains no PI component, i.e., that the measured counter substrate 11 is non-defective product.

Thus, the foregoing arrangement, which includes a determining step of determining, from the spectrum of the reflected light obtained in the reflected light obtaining step, whether a residue of the alignment film 21 is present or absent on the apical surface 51a of any switch PS electrode 51, makes it possible to determine the presence or absence of a residue of the alignment film 21 on the apical surface 51a of any switch PS electrode 51.

This prevents a misjudgment from being made by an inspector, thus making it possible to efficiently and surely check the presence or absence of an element that causes a failure to occur in any of those switches.

The present invention is not limited to the description of the embodiments above, but may be altered by a skilled person within the scope of the claims. An embodiment based on a proper combination of technical means disclosed in different embodiments is encompassed in the technical scope of the present invention.

As described above, in order to solve the foregoing problems, a liquid crystal display panel substrate of the present invention is a liquid crystal display panel substrate that constitutes a liquid crystal display panel by being placed opposite the other substrate with a liquid crystal layer sandwiched between the liquid crystal display panel substrate and the other substrate, the other substrate including a plurality of electrodes or plural sets of electrodes, the liquid crystal display panel substrate including: a plurality of switching electrodes or plural sets of switching electrodes each of which forms a switch with a corresponding one of the plurality of electrodes or with a corresponding one of the plural sets of electrodes, the plurality of switching electrodes or the plural sets of switching electrodes being each disposed so as to make electrical conduction with the corresponding one of the plurality of electrodes or with the corresponding one of the plural sets of electrodes when either the liquid crystal display panel substrate or the other substrate is pressed against the other with the liquid crystal display panel substrate placed opposite the other substrate; and reflection coatings which reflect infrared light, the reflection coatings being disposed below each separate one of the plurality of switching electrodes or below each separate one of the plural sets of switching electrodes.

According to the foregoing configuration, the plurality of switching electrodes or the plural sets of switching electrodes forms a switch with a corresponding one of the plurality of electrodes or with a corresponding one of the plural sets of electrodes of the other substrate when the liquid crystal display panel substrate is placed opposite the other substrate. Moreover, when either the liquid crystal display panel substrate or the other substrate is pressed against the other, the switch conducts electricity. This allows the switch to function as a sensor to detect the position of such electrical conduction.

Furthermore, according to the foregoing configuration, the reflection coatings, which reflect infrared light, are disposed below each separate one of the plurality of switching electrodes or below each separate one of the plural sets of switching electrodes. This allows infrared light let in through surfaces of the switching electrodes before the liquid crystal display panel substrate is placed opposite the other substrate to be reflected by the reflection coatings. Therefore, by measuring the spectrum of light reflected by the reflection coatings, an inspection can be carried out as to the presence or absence, on the surface of any of the switching electrodes, of an element that causes faulty electrical conduction with any of the electrodes of the other substrate.

This makes it possible to more efficiently and more surely check the presence or absence of an element that causes a failure to occur in any of those switches, as compared to the case of a visual check made with a microscope.

Further, the liquid crystal display panel substrate is preferably configured to further include an alignment film formed so that surfaces of the switching electrodes serve as alignment-film-free regions on which the alignment film is selectively not provided, wherein when the liquid crystal display panel substrate is seen in plan view, each of the reflection coatings appears to be overlapping a corresponding one(s) of the alignment-film-free regions.

According to the foregoing configuration, since each of the reflection coatings overlaps a corresponding one(s) of the alignment-film-free regions, infrared light emitted onto the alignment-film-free region(s) can be reflected by the reflection coating. Therefore, by measuring the spectrum of light reflected by the reflection coating, an inspection can be carried out as to the presence or absence of a residue of the alignment film in (any of) the alignment-film-free region(s). This makes it possible to more efficiently and more surely check the presence or absence, on the surface of any of the switching electrodes, of a residue of the alignment film that causes a failure to occur in the switch.

Further, the liquid crystal display panel substrate is preferably configured such that the reflection coatings are made of a metal material. This configuration allows the reflection coatings to reflect infrared light.

Further, the liquid crystal display panel substrate is preferably configured such that the metal material of which the reflection coatings are made is identical to a material of which wires or electrodes of an active substrate serving as the liquid crystal display panel substrate are made. This configuration eliminates the need to prepare another metal material for forming the reflection coatings, thus making it possible to suppress a rise in manufacturing cost.

Further, the liquid crystal display panel substrate is preferably configured such that the reflection coatings are composed mainly of tantalum, molybdenum, titanium, copper, or aluminum.

The foregoing configuration allows the reflection coatings to be made of the same metal material as that of which the wires or electrodes of the liquid crystal display panel substrate are made. This makes it possible to prevent a rise in manufacturing cost due to formation of the reflection coatings.

Further, the liquid crystal display panel substrate is preferably configured such that each of the switching electrodes includes a transparent electrode.

The foregoing configuration allows the transparent electrode of each of the switching electrodes to be formed in a step identical to the step of forming pixel electrodes that are generally formed in an active substrate serving as the liquid crystal display panel substrate or the step of forming a common electrode that is generally formed in the counter substrate.

This eliminates the need to set up a step solely for forming the electrode of each of the switch electrodes, thus making it possible to prevent a rise in manufacturing cost.

Further, the liquid crystal display panel substrate is preferably configured to further include pixel electrodes formed in a step identical to a step executed in forming the transparent electrode. This configuration allows the liquid crystal display panel substrate to serve as an active substrate.

Further, the liquid crystal display panel substrate is preferably configured to further include a common electrode formed in a step identical to a step executed in forming the transparent electrode. This configuration allows the liquid crystal display panel substrate to serve as a counter substrate.

Further, the liquid crystal display panel substrate is preferably configured such that each of the switching electrodes is constituted by (i) the transparent electrode and (ii) a structure having a protruding shape with the transparent electrode stacked on the structure.

According to the foregoing configuration, each of the switching electrodes is constituted by (i) such a structure having a protruding shape and (ii) the transparent electrode stacked on the structure, and as such, has a protruding shape, too. This makes it possible to surely make electrical conduction between each of the plurality of switching electrodes or each of the plural sets of switching electrodes and the corresponding one of the plurality of electrodes or the corresponding one of the plural sets of electrodes when either the liquid crystal display panel substrate or the other substrate is pressed against the other with the liquid crystal display panel substrate placed opposite the other substrate.

Further, the liquid crystal display panel substrate is preferably configured such that the structure is made of acrylic. Since the acrylic is generally used for liquid crystal display panel substrates, the foregoing configuration eliminates the need to use another material to form the structure, thus making it possible to prevent a rise in manufacturing cost.

Further, a liquid crystal display panel of the present invention preferably includes: such a liquid crystal display panel substrate as that described above; and the other substrate placed opposite the liquid crystal display panel substrate. This configuration makes it possible to efficiently and surely provide a liquid crystal display panel free from an element that causes a failure to occur in any of those switches.

As described above, in order to solve the foregoing problems, a liquid crystal display panel of the present invention is a liquid crystal display panel including an active substrate, a liquid crystal layer, and a counter substrate placed opposite the active substrate with the liquid crystal layer sandwiched therebetween, the liquid crystal display panel including: switches each constituted by a first switching electrode or a set of first switching electrodes of the active substrate and a second switching electrode or a set of second switching electrodes of the counter substrate so as to conduct electricity when the active substrate or the counter substrate is pressed; and at least either first reflection coatings which reflect infrared light or second reflection coatings which reflect infrared light, the first reflection coatings being provided in the active substrate with the first switching electrode or the set of first switching electrodes stacked on a corresponding one of the first reflection coatings, the second reflection coatings being provided in the counter substrate with the second switching electrode or the set of second switching electrodes stacked on a corresponding one of the second reflection coatings.

According to the foregoing configuration, each of the switches is such that the first switching electrode or the set of first switching electrodes and the second switching electrode or the set of second switching electrodes make electrical conduction when the active substrate or the counter substrate is pressed. This allows each of the switches to function, for example, as a sensor to detect the position of such electrical conduction.

Furthermore, according to the foregoing configuration, the liquid crystal display panel includes at least either first reflection coatings which reflect infrared light or second reflection coatings which reflect infrared light, the first reflection coatings being provided in the active substrate with the first switching electrode or the set of first switching electrodes stacked on a corresponding one of the first reflection coatings, the second reflection coatings being provided in the counter substrate with the second switching electrode or the set of second switching electrodes stacked on a corresponding one of the second reflection coatings.

This allows infrared light let in through surfaces of those first or second switching electrodes before the active substrate and the counter substrate are placed opposite each other to be reflected by at least either the first or second reflection coatings. Therefore, by measuring the spectrum of light reflected by the first and second reflection coatings, an inspection can be carried out as to the presence or absence, on the surface of any of at least either the first or second switching electrodes, of an element that causes faulty electrical conduction between the first and second switching electrodes.

This makes it possible to more efficiently and more surely check the presence or absence of an element that causes a failure to occur in any of those switches, as compared to the case of a visual check made with a microscope.

Further, the liquid crystal display panel is preferably configured to includes both the first reflection coatings and the second reflection coatings.

The foregoing configuration makes it possible to check the presence or absence, on the surface of any of the first and second switching electrodes, of an element that causes faulty electrical conduction between the first switching electrode and the second switching electrode.

This makes it possible to efficiently and surely check the presence or absence of an element that causes a failure to occur in any of those switches.

Further, the liquid crystal display panel is preferably configured such that at least either (i) the first switching electrode or the set of first switching electrodes or (ii) the second switching electrode or the set of second switching electrodes has(have) a protruding shape(s). This configuration makes it possible to provide a switch that conducts electricity when the active substrate or the counter substrate is pressed.

Further, the liquid crystal display panel is preferably configured such that the first switching electrode or the set of first switching electrodes and the second switching electrode or the set of second switching electrodes have protruding shapes. This configuration makes it possible to more surely make electrical conduction between the first switching electrode or the set of first switching electrodes and the second switching electrode or the set of second switching electrodes when the active substrate or the counter substrate is pressed, thus making it possible to prevent faulty electrical conduction or the like from occurring.

In order to solve the foregoing problems, a method of the present invention for fabricating a liquid crystal display panel substrate is a method for fabricating a liquid crystal display panel substrate that constitutes a liquid crystal display panel being placed opposite the other substrate with a liquid crystal layer sandwiched between the liquid crystal display panel substrate and the other substrate, the other substrate including a plurality of electrodes or plural sets of electrodes, the method including: a reflection coating forming step of forming reflection coatings which reflect infrared light; a switching electrode forming step of forming, above each separate one of the reflection coatings formed in the reflection coating forming step, a plurality of switching electrodes or plural sets of switching electrodes each of which forms a switch with a corresponding one of the plurality of electrodes or with a corresponding one of the plural sets of electrodes, and each of which makes electrical conduction with the corresponding one of the plurality of electrodes or with the corresponding one of the plural sets of electrodes when either the liquid crystal display panel substrate or the other substrate is pressed against the other with the liquid crystal display panel substrate placed opposite the other substrate.

According to the foregoing arrangement, in the switching electrode forming step, the plurality of switching electrodes or the plural sets of switching electrodes are formed above each separate one of the reflection coatings, which reflect infrared light, formed in the reflection coating forming step. This makes it possible to fabricate a liquid crystal display panel that allows infrared light let in through surfaces of the switching electrodes to be reflected by the reflection coatings.

This makes it possible to fabricate a liquid crystal display panel that makes it possible that by measuring the spectrum of light reflected by the reflection coatings, an inspection can be carried out as to the presence or absence, on the surface of any of the switching electrodes, of an element that causes faulty electrical conduction with the corresponding one of the plurality of electrodes or with the corresponding one of the plural sets of electrodes of the other substrate.

This makes it possible to fabricate a liquid crystal display panel substrate that makes it possible to more efficiently and more surely check the presence or absence of an element that causes a failure to occur in any of those switches, as compared to the case of a visual check made with a microscope.

Further, the method is preferably arranged to further include an alignment film forming step of forming an alignment film in an area around alignment-film-free regions on which the alignment film is selectively not deposited, the alignment-film-free regions being surfaces of the switching electrodes formed in the switching electrode forming step.

According to the foregoing arrangement, the alignment film, which may cause faulty electrical conduction with an electrode of the other substrate placed opposite the liquid crystal display panel substrate, is formed in the liquid crystal display panel substrate without being formed on the surfaces of the switching electrodes. This makes it possible to fabricate a liquid crystal display panel substrate provided with switching electrodes that prevent faulty electrical conduction from occurring.

Further, the method is preferably arranged to further include: an infrared light emitting step of emitting infrared light onto the alignment-film-free regions; a reflected light obtaining step of obtaining reflected light from the reflection coatings reflecting the infrared light emitted in the infrared light emitting step; and a spectrum displaying step of displaying a spectrum of the reflected light obtained in the reflected light obtaining step.

According to the foregoing arrangement, infrared light is emitted onto the alignment-film-free regions in the infrared light emitting step, and reflected light from the reflection coatings reflecting the infrared light emitted in the infrared light emitting step is obtained in reflected light obtaining step. Then, a spectrum of the light reflected by the reflection coatings is displayed in the spectrum displaying step. For example, having an inspector view the spectrum, for example, makes it possible for the inspector to check the presence or absence, on the surface of any of the switching electrodes, an element that causes faulty electrical conduction with the corresponding one of the plurality of electrodes or with the corresponding one of the plural sets of electrodes of the other substrate.

Thus, the foregoing arrangement makes it possible to fabricate a liquid crystal display panel substrate while efficiently and surely checking the presence or absence of an element that causes a failure to occur in any of those switches.

Further, the method is preferably arranged to further include a determining step of determining, from the spectrum of the reflected light obtained in the reflected light obtaining step, whether the alignment film is present or absent on the surface of any of the switching electrodes.

According to the foregoing arrangement, the determining step makes it possible to determine the presence or absence of the alignment film. This prevents a misjudgment from being made by an inspector, thus making it possible to fabricate a liquid crystal display panel substrate while efficiently and surely checking the presence or absence of an element that causes a failure to occur in any of those switches.

In order to solve the foregoing problems, a method of the present invention for inspecting a liquid crystal display panel substrate is a method for inspecting a liquid crystal display panel substrate that constitutes a liquid crystal display panel being placed opposite the other substrate with a liquid crystal layer sandwiched between the liquid crystal display panel substrate and the other substrate, the other substrate including a plurality of electrodes or plural sets of electrodes, the method including: an infrared light emitting step of emitting infrared light onto a plurality of switching electrodes or plural sets of switching electrodes each of which forms a switch with a corresponding one of the plurality of electrodes or with a corresponding one of the plural sets of electrodes of the other substrate, and each of which makes electrical conduction with the corresponding one of the plurality of electrodes or with the corresponding one of the plural sets of electrodes of the other substrate when either the liquid crystal display panel substrate or the other substrate is pressed against the other with the liquid crystal display panel substrate placed opposite the other substrate; and a reflected light obtaining step of obtaining reflected light from reflection coatings reflecting the infrared light emitted in the infrared light emitting step, when the liquid crystal display panel substrate is seen in plan view, each of the reflection coatings appearing to be overlapping a corresponding one(s) of the switching electrodes.

The foregoing arrangement includes: the infrared light emitting step of emitting infrared light onto the plurality of switching electrodes or the plural sets of switching electrodes; and the reflected light obtaining step of obtaining reflected light from reflection coatings reflecting the infrared light emitted in the infrared light emitting step, with the switching electrodes or the plural sets of switching electrodes stacked on each separate one of the reflection coatings. This makes it possible to determine, from the reflected light thus obtained, the presence or absence, on the surface of any of the switching electrodes, an element that causes faulty electrical conduction the corresponding one of the plurality of electrodes or with the corresponding one of the plural sets of electrodes of the other substrate.

For this reason, the foregoing arrangement makes it possible to efficiently and surely check the presence or absence of an element that causes a failure to occur in any of those switches.

Further, the method is preferably arranged to further include a spectrum displaying step of displaying a spectrum of the reflected light obtained in the reflected light obtaining step.

Having an inspector visually check the spectrum of the reflected light as displayed in the displaying step, for example, makes it possible to have the inspector check the presence or absence, on the surface of any of the switching electrodes, an element that causes faulty electrical conduction with the corresponding one of the plurality of electrodes or with the corresponding one of the plural sets of electrodes of the other substrate.

Further, the method is preferably arranged to further include a determining step of determining, from the spectrum of the reflected light obtained in the reflected light obtaining step, whether an alignment film is present or absent on a surface of any of the switching electrodes.

According to the foregoing arrangement, the determining step makes it possible to determine the presence or absence of an alignment film on a surface of any of the switching electrodes. This prevents a misjudgment from being made by an inspector, thus making it possible to fabricate a liquid crystal display panel substrate while efficiently and surely checking the presence or absence of an element that causes a failure to occur in any of those switches.

Further, the method is preferably arranged to further include a conversion-into-spectrum step of converting the reflected light obtained in the reflected light obtaining step into a spectrum. According this arrangement, the conversion-into-spectrum step makes it possible to convert the reflected light into a spectrum.

Further, the method is preferably arranged such that the conversion-into-spectrum step is executed with infrared light whose wave number falls within a mid-infrared range of 4000 cm⁻¹ to 650 cm⁻¹. This arrangement makes it possible to, while reducing the volume of data to be obtained, obtain data on a spectrum necessary for checking the presence or absence, on the surface of any of the switching electrodes, an element that causes faulty electrical conduction with the corresponding one of the plurality of electrodes or with the corresponding one of the plural sets of electrodes of the other substrate.

Further, the method is preferably arranged to further include the step of checking the spectrum obtained in the conversion-into-spectrum step for any molecular vibrations due to C—H stretching, C═O stretching, benzene ring CC stretching, C—N stretching, C—O stretching, and benzene ring CH out-of-plane bending.

The foregoing arrangement allows an inspector, for example, to determine whether or not the spectrum indicates the presence of any molecular vibrations due to C—H stretching, C═O stretching, benzene ring CC stretching, C—N stretching, C—O stretching, and benzene ring CH out-of-plane bending, thereby allowing the inspector to determine whether or not the reflected light contains any component indicative of acrylic and polyimide.

This makes it possible, in a case where each of the switching electrodes each stacked on a corresponding one of the reflection coatings is constituted by a component made of an acrylic material and a component made of ITO, to determine whether or not polyimide, which is generally used as an alignment film, is stacked on that switching electrode. This makes it possible to efficiently and surely check the presence or absence of an alignment film that causes a failure to occur in any of those switches.

### INDUSTRIAL APPLICABILITY

The present invention is applicable to a liquid crystal display panel substrate that constitutes an in-cell liquid crystal display panel having touch switches disposed inside thereof, a liquid crystal display panel, a method for fabricating a liquid crystal display panel substrate, and a substrate inspection method.

### REFERENCE SIGNS LIST

1, 130, 135 Liquid crystal display panel
3 Liquid crystal display device
5 Pixel
10 Liquid crystal layer
11, 136 Counter substrate (liquid crystal display panel substrate, other substrate)
12, 131 Active substrate (liquid crystal display panel substrate, other substrate)
15 Pixel electrode (electrode)
16 TFT
21, 32 Alignment film
27, 155 Transparent electrode (electrode, common electrode)
37 Interlayer insulating film
38 Reflection coating (second reflection coating)
39 Reflection coating (first reflection coating)
50, 150, 160 Touch switch (switch)
51, 61 Switch PS electrode (switching electrode, sets of switching electrodes, electrode of the other substrate, sets of electrodes of the other substrate, second switching electrode)
51a, 61a, 152a Apical surface (alignment-film-free region)
52, 152 Switch electrode (electrode of the other substrate, sets of electrodes of the other substrate, switching electrode, sets of switching electrodes, first switching electrode)
52a Surface (alignment-film-free region)
58 Switch PS (structure)
100, 100a Switching electrode inspection apparatus
101 Spectrophotometer
102 Light source
103 Detector
110, 110a Control section
111 Driving control section
112, 112a Data conversion section
113 Spectrum determination section
114 Spectrum storage section
120 Display section
158 Columnar protrusion (structure)
161 Switching electrode (switching electrode, electrode of the other substrate, second switching electrode)
161a Front surface (alignment-film-free region)

1. A liquid crystal display panel substrate that constitutes a liquid crystal display panel by being placed opposite the other substrate with a liquid crystal layer sandwiched between the liquid crystal display panel substrate and the other substrate, the other substrate including a plurality of electrodes or plural sets of electrodes, the liquid crystal display panel substrate comprising:
a plurality of switching electrodes or plural sets of switching electrodes each of which forms a switch with a corresponding one of the plurality of electrodes or with a corresponding one of the plural sets of electrodes, the plurality of switching electrodes or the plural sets of switching electrodes being each disposed so as to make electrical conduction with the corresponding one of the plurality of electrodes or with the corresponding one of the plural sets of electrodes when either the liquid crystal display panel substrate or the other substrate is pressed against the other with the liquid crystal display panel substrate placed opposite the other substrate; and
reflection coatings which reflect infrared light, the reflection coatings being disposed below each separate one of the plurality of switching electrodes or below each separate one of the plural sets of switching electrodes.

2. The liquid crystal display panel substrate as set forth in claim 1, further comprising an alignment film formed so that surfaces of the switching electrodes serve as alignment-film-free regions on which the alignment film is selectively not provided, wherein
when the liquid crystal display panel substrate is seen in plan view, each of the reflection coatings appears to be overlapping a corresponding one(s) of the alignment-film-free regions.

3. The liquid crystal display panel substrate as set forth in claim 1, wherein the reflection coatings are made of a metal material.

4. The liquid crystal display panel substrate as set forth in claim 3, wherein the metal material of which the reflection coatings are made is identical to a material of which wires or electrodes of an active substrate serving as the liquid crystal display panel substrate are made.

5. The liquid crystal display panel substrate as set forth in claim 3, wherein the reflection coatings are composed mainly of tantalum, molybdenum, titanium, copper, or aluminum.

6. The liquid crystal display panel substrate as set forth in claim 1, wherein each of the switching electrodes includes a transparent electrode.

7. The liquid crystal display panel substrate as set forth in claim 6, further comprising pixel electrodes formed in a step identical to a step executed in forming the transparent electrode.

8. The liquid crystal display panel substrate as set forth in claim 6, further comprising a common electrode formed in a step identical to a step executed in forming the transparent electrode.

9. The liquid crystal display panel substrate as set forth in claim 6, wherein each of the switching electrodes is constituted by (i) the transparent electrode and (ii) a structure having a protruding shape with the transparent electrode stacked on the structure.

10. The liquid crystal display panel substrate as set forth in claim 9, wherein the structure is made of acrylic.

11. A liquid crystal display panel comprising:
a liquid crystal display panel substrate as set forth in claim 7; and
the other substrate placed opposite the liquid crystal display panel substrate.

12. A liquid crystal display panel including an active substrate, a liquid crystal layer, and a counter substrate placed opposite the active substrate with the liquid crystal layer sandwiched therebetween, the liquid crystal display panel comprising:
switches each constituted by a first switching electrode or a set of first switching electrodes of the active substrate and a second switching electrode or a set of second switching electrodes of the counter substrate so as to conduct electricity when the active substrate or the counter substrate is pressed; and
at least either first reflection coatings which reflect infrared light or second reflection coatings which reflect infrared light, the first reflection coatings being provided in the active substrate with the first switching electrode or the set of first switching electrodes stacked on a corresponding one of the first reflection coatings, the second reflection coatings being provided in the counter substrate with the second switching electrode or the set of second switching electrodes stacked on a corresponding one of the second reflection coatings.

13. The liquid crystal display panel as set forth in claim 12, said liquid crystal panel includes both the first reflection coatings and the second reflection coatings.

14. The liquid crystal display panel as set forth in claim 12, at least either (i) the first switching electrode or the set of the first switching electrodes or (ii) the second switching electrode or the set of second switching electrodes has(have) a protruding shape(s).

15. The liquid crystal display panel as set forth in claim 14, the first switching electrode or the set of first switching electrodes and the second switching electrode or the set of second switching electrodes have protruding shapes.

16. A method for fabricating a liquid crystal display panel substrate that constitutes a liquid crystal display panel being placed opposite the other substrate with a liquid crystal layer sandwiched between the liquid crystal display panel substrate and the other substrate, the other substrate including a plurality of electrodes or plural sets of electrodes, the method comprising:
a reflection coating forming step of forming reflection coatings which reflect infrared light;
a switching electrode forming step of forming, above each separate one of the reflection coatings formed in the reflection coating forming step, a plurality of switching electrodes or plural sets of switching electrodes each of which forms a switch with a corresponding one of the plurality of electrodes or with a corresponding one of the plural sets of electrodes, and each of which makes electrical conduction with the corresponding one of the plurality of electrodes or with the corresponding one of the plural sets of electrodes when either the liquid crystal display panel substrate or the other substrate is pressed against the other with the liquid crystal display panel substrate placed opposite the other substrate.

17. The method as set forth in claim 16, further comprising an alignment film forming step of forming an alignment film in an area around alignment-film-free regions on which the alignment film is selectively not deposited, the alignment-film-free regions being surfaces of the switching electrodes formed in the switching electrode forming step.

18. The method as set forth in claim 17, further comprising:
an infrared light emitting step of emitting infrared light onto the alignment-film-free regions;
a reflected light obtaining step of obtaining reflected light from the reflection coatings reflecting the infrared light emitted in the infrared light emitting step; and
a spectrum displaying step of displaying a spectrum of the reflected light obtained in the reflected light obtaining step.

19. The method as set forth in claim 18, further comprising a determining step of determining, from the spectrum of the reflected light obtained in the reflected light obtaining step, whether the alignment film is present or absent.

20-25. (canceled)
